(19) United States
(12) Patent Application Publication
(10) Pub. No.: US 2026/0024502 A1
(43) Pub. Date: Jan. 22, 2026

(54) Array Substrate, and Display Panel

(71) Applicants: CHENGDU BOE OPTOELECTRONICS TECHNOLOGY CO., LTD., Chengdu, Sichuan (CN); BOE TECHNOLOGY GROUP CO., LTD., Chaoyang District, Beijing (CN)

(72) Inventors: Jingwen Zhang, Beijing (CN); Ziyang Yu, Beijing (CN); Haigang Qing, Beijing (CN); Gukhwan Song, Beijing (CN); Wenhui Gao, Beijing (CN)

(21) Appl. No.: 18/851,000

(22) PCT Filed: Jun. 30, 2023
(86) PCT No.: PCT/CN2023/105193

§ 371 Date: Sep. 25, 2024

(51) Int. Cl. G09G 3/3275

(52) U.S. Cl. CPC G09G 3/3275

(57) ABSTRACT

An array substrate includes a substrate, pixel driving circuits and first scanning signal lines. Any pixel driving circuit includes a driving transistor, a compensation transistor and a first conductive connection portion. The first scanning signal lines extending in the first direction and arranged in the second direction. A control electrode of the driving transistor is electrically connected to the first conductive connection portion, a control electrode of the compensation transistor is electrically connected to a first scanning signal line, a second electrode of the compensation transistor is electrically connected to the first conductive connection portion, and a first electrode of the compensation transistor electrically connected to a second electrode of the driving transistor. An orthographic projection of the first scanning signal line on the substate is non-overlapping with an orthographic projection of the first conductive connection portion on the substrate.

### CROSS-REFERENCE TO RELATED APPLICATION

This application is the United States national phase of International Patent Application No. PCT/CN2023/105193, filed on Jun. 30, 2023, the disclosure of which is hereby incorporated by reference in its entirety.

### BACKGROUND OF THE INVENTION

### Field of the Invention

The present disclosure relates to the field of display technologies, and in particular, to an array substrate and a display panel.

### Description of Related Art

Organic light-emitting diode (OLED) display devices have become one of the very competitive and promising display devices due to their series of advantages such as self-illumination, fast response speed, high brightness, full viewing angle, and flexible display.

### SUMMARY OF THE INVENTION

In an aspect, an array substrate is provided. The array substrate includes a substrate, a plurality of pixel driving circuits and a plurality of first scanning signal lines. The plurality of pixel driving circuits are located on a side of the substrate and are arranged in a plurality of rows and columns. Any pixel driving circuit of the plurality of pixel driving circuits includes a driving transistor, a compensation transistor electrically connected to the driving transistor, and a first conductive connection portion. The plurality of first scanning signal lines are located on the side of the substrate, extend in a first direction and are arranged in a second direction, and the second direction intersects the first direction. A control electrode of the driving transistor is electrically connected to the first conductive connection portion, a control electrode of the compensation transistor is electrically connected to a first scanning signal line, a second electrode of the compensation transistor is electrically connected to the first conductive connection portion, and a first electrode of the compensation transistor is electrically connected to a second electrode of the driving transistor. An orthographic projection of the first scanning signal line on the substrate is non-overlapping with an orthographic projection of the first conductive connection portion on the substrate.

In some embodiments, the any pixel driving circuit further includes a second conductive connection portion, and a first electrode of the driving transistor is electrically connected to the second conductive connection portion. The orthographic projection of the first scanning signal line on the substrate is non-overlapping with an orthographic projection of the second conductive connection portion on the substrate.

In some embodiments, the orthographic projection of the first conductive connection portion on the substrate is located between an orthographic projection of the driving transistor on the substrate and the orthographic projection of the first scanning signal line on the substrate.

In some embodiments, the second conductive connection portion and the driving transistor are located on a same side of the first scanning signal line in the second direction; and in the first direction, an orthographic projection of the second conductive connection portion on the substrate is located on a side of the orthographic projection of the first conductive connection portion on the substrate away from an orthographic projection of the compensation transistor on the substrate.

In some embodiments, the orthographic projection of the first scanning signal line on the substrate is non-overlapping with an orthographic projection of the control electrode of the driving transistor on the substrate.

In some embodiments, the orthographic projection of the first scanning signal line on the substrate is non-overlapping with an orthographic projection of a first electrode of the driving transistor on the substrate; and/or the orthographic projection of the first scanning signal line on the substrate is non-overlapping with an orthographic projection of the second electrode of the driving transistor on the substrate.

In some embodiments, the array substrate further includes a plurality of data writing signal lines and a plurality of second scanning signal lines. The plurality of data writing signal lines are located on the side of the substrate, and extend in the second direction and are arranged in the first direction. The plurality of second scanning signal lines are located on the side of the substrate, and extend in the first direction and are arranged in the second direction. The pixel driving circuit further includes a data writing transistor, a first electrode of the data writing transistor is electrically connected to a data writing signal line, a second electrode of the data writing transistor is electrically connected to a first electrode of the driving transistor, and a control electrode of the data writing transistor is electrically connected to a second scanning signal line. In the first direction, an orthographic projection of the data writing transistor on the substrate is located on a side of an orthographic projection of the driving transistor on the substrate away from an orthographic projection of the compensation transistor on the substrate.

In some embodiments, in the second direction, the orthographic projection of the first scanning signal line on the substrate is located on a side of an orthographic projection of the second scanning signal line on the substrate away from the orthographic projection of the driving transistor on the substrate.

In some embodiments, the orthographic projection of the first scanning signal line on the substrate is non-overlapping with an orthographic projection of the second electrode of the data writing transistor on the substrate.

In some embodiments, the array substrate further includes a plurality of first initialization signal lines and a plurality of first reset signal lines. The plurality of first initialization signal lines are located on the side of the substrate, and extend in the first direction and are arranged in the second direction. The plurality of first reset signal lines are located on the side of the substrate, and extend in the first direction and are arranged in the second direction. The pixel driving circuit further includes a first reset transistor; a control electrode of the first reset transistor is electrically connected to a first reset signal line, a first electrode of the first reset transistor is electrically connected to a first initialization signal line, and a second electrode of the first reset transistor is electrically connected to the second electrode of the driving transistor. In the second direction, an orthographic projection of the first reset signal line on the substrate is located on a side of the orthographic projection of the first scanning signal line on the substrate away from an orthographic projection of the driving transistor on the substrate.

In some embodiments, the array substrate further includes a plurality of enable signal lines and a plurality of first power supply signal lines. The plurality of enable signal lines are located on the side of the substrate, and extend in the first direction and are arranged in the second direction. The plurality of first power supply signal lines are located on the side of the substrate, and extend in the second direction and are arranged in the first direction. The pixel driving circuit further includes a first light-emitting control transistor; a control electrode of the first light-emitting control transistor is electrically connected to an enable signal line, a first electrode of the first light-emitting control transistor is electrically connected to a first power supply signal line, and a second electrode of the first light-emitting control transistor is electrically connected to a first electrode of the driving transistor. In the second direction, an orthographic projection of the enable signal line on the substrate is located on a side of an orthographic projection of the driving transistor on the substrate away from the orthographic projection of the first scanning signal line on the substrate.

In some embodiments, the array substrate further includes a plurality of second initialization signal lines and a plurality of second reset signal lines. The plurality of second initialization signal lines are located on the side of the substrate, and extend in the first direction and are arranged in the second direction. The plurality of second reset signal lines are located on the side of the substrate, and extend in the first direction and are arranged in the second direction. The pixel driving circuit further includes a second reset transistor; a control electrode of the second reset transistor is electrically connected to a second reset signal line, a first electrode of the second reset transistor is electrically connected to a second initialization signal line, and a second electrode of the second reset transistor is configured to be electrically connected to a light-emitting device. In the second direction, an orthographic projection of the second reset signal line on the substrate is located on a side of the orthographic projection of the enable signal line on the substrate away from the orthographic projection of the driving transistor on the substrate.

In some embodiments, the array substrate further includes a plurality of third initialization signal lines and a plurality of third reset signal lines. The plurality of third initialization signal lines are located on the side of the substrate, and extend in the first direction and are arranged in the second direction. The plurality of third reset signal lines are located on the side of the substrate, and extend in the first direction and are arranged in the second direction. The pixel driving circuit further includes a third reset transistor; a control electrode of the third reset transistor is electrically connected to a third reset signal line, a first electrode of the third reset transistor is electrically connected to an third initialization signal line, and a second electrode of the third reset transistor is electrically connected to a first electrode of the driving transistor. The orthographic projection of the enable signal line on the substrate at least partially overlaps with an orthographic projection of the third initialization signal line on the substrate.

In some embodiments, an orthographic projection of the first electrode of the driving transistor on the substrate at least partially overlaps with the orthographic projection of the third initialization signal line on the substrate.

In some embodiments, the compensation transistor a semiconductor structure, and the semiconductor structure includes a first portion; an orthographic projection of the first portion on the substrate is located between the orthographic projection of the first scanning signal line on the substrate and an orthographic projection of the driving transistor on the substrate. The first portion is electrically connected to the first conductive connection portion, and the orthographic projection of the first portion on the substrate overlaps with an orthographic projection of a second scanning signal line on the substrate.

In some embodiments, the compensation transistor a semiconductor structure; the semiconductor structure includes a first portion, and an orthographic projection of the first portion on the substrate is located between the orthographic projection of the first scanning signal line on the substrate and an orthographic projection of the driving transistor on the substrate. In an extension direction of the second scanning signal line, the first portion includes a first sub-portion and a second sub-portion that connected; wherein an orthographic projection of the second sub-portion on the substrate is located between an orthographic projection of the first sub-portion on the substrate and an orthographic projection of the control electrode of the compensation transistor on the substrate, and the first sub-portion is electrically connected to the first conductive connection portion. Orthographic projections of the first sub-portion and the second sub-portion on the substrate both overlap with an orthographic projection of the second scanning signal line on the substrate.

In some embodiments, the semiconductor structure further includes a second portion and a third portion, the first sub-portion protrudes toward the data writing transistor relative to the second portion, and in the first direction, a width of the third portion is substantially equal to a width of the second portion.

In some embodiments, the compensation transistor includes a semiconductor structure; the semiconductor structure includes a first portion, an orthographic projection of the first portion on the substrate located between the orthographic projection of the first scanning signal line on the substrate and the orthographic projection of the driving transistor on the substrate. In the extension direction of a second scanning signal line, the first portion includes a third sub-portion, a fourth sub-portion and a fifth sub-portion that connected, and the fourth sub-portion is located between the third sub-portion and the fifth sub-portion. The fourth sub-portion is the first electrode of the compensation transistor, and the fourth sub-portion is electrically connected to the first conductive connection portion. Orthogonal projections of the third sub-portion, the fourth sub-portion and the fifth sub-portion on the substrate each overlap with an orthogonal projection of the second scanning signal line on the substrate.

In some embodiments, the compensation transistor includes a semiconductor structure, the semiconductor structure includes a first portion, a second portion and a third portion; the second portion is a channel of the compensation transistor, and the third portion is the first electrode of the compensation transistor, and the first portion is electrically connected to the first conductive connection portion. An orthographic projection of the first portion on the substrate and an orthographic projection of a second scanning signal line on the substrate have a first overlapping region, and an area of the first overlapping region is greater than an area of an orthographic projection of the second portion on the substrate.

In some embodiments, the semiconductor structure further includes a second portion and a third portion, the second portion is a channel of the compensation transistor, and the third portion is the first electrode of the compensation transistor. The pixel driving circuit further includes a third conductive connection portion, the first electrode of the compensation transistor is electrically connected to the third conductive connection portion, and the second electrode of the driving transistor is electrically connected to the third conductive connection portion. An orthographic projection of the third conductive connection portion on the substrate overlaps with an orthographic projection of the second portion on the first substrate.

In some embodiments, the semiconductor structure further includes a second portion and a third portion, the second portion is a channel of the compensation transistor, and the third portion is the first electrode of the compensation transistor. The pixel driving circuit further includes a third conductive connection portion, the first electrode of the compensation transistor is electrically connected to the third conductive connection portion, and the second electrode of the driving transistor is electrically connected to the third conductive connection portion. The first scanning signal line includes a first portion and a second portion, and an orthographic projection of the first portion of the first scanning signal line on the substrate overlaps with an orthographic projection of the second portion of the semiconductor structure on the substrate, an orthographic projection of the second portion of the first scanning signal line on the substrate overlaps with an orthographic projection of the third conductive connection portion on the substrate, wherein in the second direction, a width of the second portion of the first scanning signal line is less than a width of the first portion of the first scanning signal line. An orthographic projection of the third conductive connection portion on the substrate is non-overlapping with the orthographic projection of the second portion of the semiconductor structure on the first substrate.

In another aspect, a display panel is provided. The display panel includes a light-emitting device layer and the array substrate as described in any one of the above embodiments and. The light-emitting device layer is located on a side of the array substrate. The light-emitting device layer includes a plurality of light-emitting devices, and a light-emitting device is electrically connected to a pixel driving circuit in the array substrate.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a display apparatus, in accordance with some embodiments;

FIG. 2 is a structural diagram of a display panel, in accordance with some embodiments;

FIG. 3 is a structural diagram of a display panel, in accordance with some embodiments;

FIG. 4 is a structural diagram of an array substrate, in accordance with some embodiments;

FIG. 5 is an equivalent circuit diagram of a pixel driving circuit, in accordance with some embodiments;

FIG. 6 is a structural diagram of a pixel driving circuit, in accordance with some implementations;

FIG. 7 is a timing diagram of a first node, a first scanning signal line, a second scanning signal line, and an enable signal line in a pixel driving circuit, in accordance with some embodiments;

FIG. 8 is a partial enlarged view of the region E in FIG. 7;

FIG. 9 is a structural diagram of a pixel driving circuit, in accordance with some embodiments;

FIG. 10 is a structural diagram of a first semiconductor layer in FIG. 9;

FIG. 11 is a structural diagram of a first gate metal layer in FIG. 9;

FIG. 12 is a structural diagram of a second gate metal layer in FIG. 9;

FIG. 13 is a structural diagram of some film layers in FIG. 9;

FIG. 14 is a structural diagram of a second semiconductor layer in FIG. 9;

FIG. 15 is a structural diagram of a third gate metal layer in FIG. 9;

FIG. 16 is a structural diagram of some other film layers in FIG. 9;

FIG. 17 is a structural diagram of a first wiring metal layer in FIG. 9;

FIG. 18 is a structural diagram of yet some other film layers in FIG. 9;

FIG. 19 is a structural diagram of a second wiring metal layer in FIG. 9;

FIG. 20 is a structural diagram of another pixel driving circuit, in accordance with some embodiments;

FIG. 21 is a structural diagram of yet another pixel driving circuit, in accordance with some embodiments;

FIG. 22 is a structural diagram of a second gate metal layer in FIG. 21;

FIG. 23 is a structural diagram of a second gate metal layer and a second semiconductor layer in FIG. 21;

FIG. 24 is a structural diagram of a first wiring metal layer in FIG. 21;

FIG. 25 is a structural diagram of yet another pixel driving circuit, in accordance with some embodiments;

FIG. 26 is a structural diagram of a second semiconductor layer in FIG. 25; and

FIG. 27 is a structural diagram of another display panel, in accordance with some embodiments.

### DESCRIPTION OF THE INVENTION

The technical solutions in embodiments of the present disclosure will be described clearly and completely with reference to the accompanying drawings. Obviously, the described embodiments are merely some but not all of embodiments of the present disclosure. All other embodiments obtained on the basis of the embodiments of the present disclosure by a person of ordinary skill in the art shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, specific features, structures, materials, or characteristics described herein may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

In the description of some embodiments, the terms “coupled”, “connected” and their derivatives may be used. The term “connection” should be understood in a broad sense. For example, “connection” may be a fixed connection, a detachable connection, or an integrated connection; alternatively, it may be a direct connection or an indirect connection through an intermediate medium. The term “coupled” indicates, for example, that two or more components are in direct physical or electrical contact. However, the term “coupled” or “communicatively coupled” may also indicate that two or more components are not in direct contact with each other, but still cooperate or interact with each other. The embodiments disclosed herein are not necessarily limited to the context herein.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

The phrase “A and/or B” includes following three combinations: only A, only B, and a combination of A and B.

As used herein, the term “if” is, optionally, construed to mean “when” or “in a case where” or “in response to determining” or “in response to detecting”, depending on the context. Similarly, the phrase “if it is determined” or “if [a stated condition or event] is detected” is, optionally, construed to mean “in a case where it is determined” or “in response to determining” or “in a case where [the stated condition or event] is detected” or “in response to detecting [the stated condition or event]”, depending on the context.

The use of “applicable to” or “configured to” herein means an open and inclusive expression, which does not exclude devices that are applicable to or configured to perform additional tasks or steps.

Additionally, the use of the phrase “based on” is meant to be open and inclusive, since a process, step, calculation or other action that is “based on” one or more of the stated conditions or values may, in practice, be based on additional conditions or value beyond those stated.

The term such as “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

The term such as “parallel”, “perpendicular” or “equal” as used herein includes a stated case and a case similar to the stated case within an acceptable range of deviation determined by a person of ordinary skill in the art, considering measurement in question and errors associated with measurement of a particular quantity (i.e., limitations of a measurement system). For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, that a difference between two equals is less than or equal to 5% of either of the two equals.

It will be understood that, when a layer or element is referred to as being on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the accompanying drawings, thicknesses of layers and sizes of regions are enlarged for clarity. Variations in shape relative to the accompanying drawings due to, for example, manufacturing technologies and/or tolerances may be envisaged. Therefore, the exemplary embodiments should not be construed as being limited to the shapes of the regions shown herein, but including deviations due to, for example, manufacturing. For example, an etched region shown in a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

In the thin film transistors employed in the circuits provided by the embodiments of the present disclosure, a first electrode of each thin film transistor is one of a source and a drain, and a second electrode of the thin film transistor is the other of the source and the drain. Since the source and the drain of the transistor may be symmetrical in structure, there may be no difference in structure between the source and the drain of the transistor. That is, there may be no difference in structure between the first electrode and the second electrode of the transistor in the embodiments of the present disclosure.

In the circuit structure provided in the embodiments of the present disclosure, a first node, a second node and other nodes do not represent actual components, but rather represent junctions of related electrical connections in a circuit diagram.

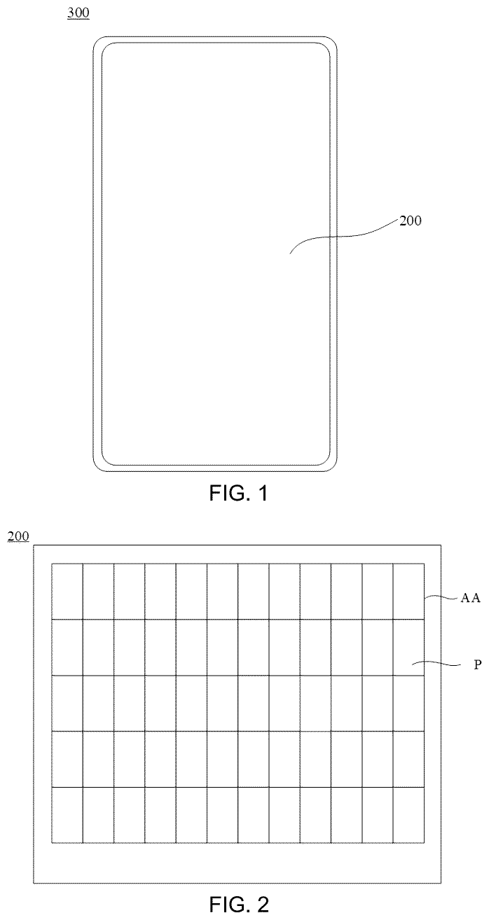

FIG. 1 is a structural diagram of a display apparatus, in accordance with some embodiments; referring to FIG. 1, some embodiments of the present disclosure provide a display apparatus 300, and the display apparatus 300 includes a display panel 200.

For example, the display apparatus 300 further includes a frame, and other electronic components.

For example, the display apparatus 300 may be an electroluminescent display apparatus or a photoluminescent display apparatus. In a case where the display apparatus is the electroluminescent display apparatus, the electroluminescent display apparatus may be an organic light-emitting diode (OLED) display apparatus or a quantum dot light-emitting diode (QLED) display apparatus. In a case where the display apparatus is the photoluminescent display apparatus, the photoluminescent display apparatus may be a quantum dot photoluminescent display apparatus.

The display apparatus 300 may be any device that can display images whether in motion (e.g., videos) or stationary (e.g., static images), and whether textual or graphical. More specifically, it is expected that the display apparatus in the embodiments may be applied to or associated with a variety of electronic devices. The plurality of electronic devices may include (but is not limit to), for example, mobile telephones, wireless devices, personal data assistants (PDAs), hand-held or portable computers, GPS receivers/navigators, cameras, MP4 video players, video cameras, game consoles, watches, clocks, calculators, TV monitors, flat panel displays, computer monitors, car displays (e.g., odometer displays), navigators, cockpit controllers and/or displays, camera view displays (e.g., rear view camera displays in vehicles), electronic photos, electronic billboards or indicators, projectors, building structures, or packagings and aesthetic structures (e.g., a display for an image of a piece of jewelry).

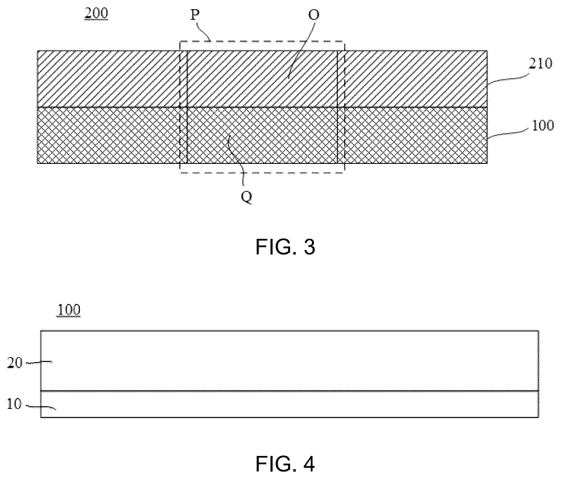

FIG. 2 is a structural diagram of a display panel, in accordance with some embodiments; FIG. 3 is a structural diagram of another display panel, in accordance with some embodiments.

Some embodiments of the present disclosure provide a display panel 200. As shown in FIGS. 2 and 3, the display panel 200 includes an active area (AA for short, also being referred as an active display area) AA. The active area AA includes a plurality of sub-pixel regions P, and the plurality of sub-pixel regions P may be arranged in an array. The sub-pixel region P is the smallest unit of the display panel 200 for image display.

In some examples, a sub-pixel region P includes a pixel driving circuit Q and a light-emitting device O electrically connected to the pixel driving circuit Q. The pixel driving circuit Q may be adjusted based on multiple different types of signal lines to generate a driving signal, and each light-emitting device O may emit light due to the driving action of the driving signal generated by the respective pixel driving circuit Q. Based on this, the light-emitting devices O may be driven by the respective pixel driving circuits Q in the plurality of sub-pixel regions to emit light, so that the display panel 200 may display a predetermined image in the active area AA. Specifically, the plurality of sub-pixel regions P may include sub-pixel regions emitting light of different colors.

For example, the plurality of sub-pixel regions P may include first sub-pixel regions, second sub-pixel regions and third sub-pixel regions. The first sub-pixel region, the second sub-pixel region and the third sub-pixel region may emit light of three primary colors. For example, the first sub-pixel region may emit red light, the second sub-pixel region may emit green light, and the third sub-pixel region may emit blue light. Based on this, by adjusting the brightness (grayscale) of sub-pixel regions P of different colors, multiple colors may be displayed through color combination and superposition, thereby achieving full-color display of the display panel 200.

As shown in FIGS. 2 and 3, the display panel 200 further includes an array substrate 100 and a light-emitting device layer 210. The array substrate 100 may include a plurality of pixel driving circuits Q. The light-emitting device layer 210 is located on a side of the array substrate 100. The light-emitting device layer 210 includes a plurality of light-emitting devices O. The light-emitting devices O are electrically connected to the pixel driving circuits Q in the array substrate 100.

In some examples, the light-emitting device O includes an anode, a light-emitting layer, and a cathode layer that are sequentially arranged. In some examples, an electron transport layer is provided between the cathode layer and the light-emitting layer, and a hole transport layer is provided between the anode layer and the light-emitting layer. For example, the light-emitting device O may be an OLED light-emitting device, but is not limited thereto. The type of the light-emitting device will not be limited in the embodiments of the present disclosure. That is, the light-emitting device O may be any other light-emitting device (e.g., a light-emitting device that emits light by discharging), as long as it is capable of emitting light to enable the display panel 200 to display images.

In some examples, the plurality of pixel driving circuits Q may be coupled to the plurality of light-emitting devices O in one-to-one correspondence. In some other examples, one pixel driving circuit Q may be coupled to multiple light-emitting devices O, or multiple pixel driving circuits Q may be coupled to one light-emitting device O.

The structure of the display panel 200 will be schematically described by taking an example in which a pixel driving circuit Q is coupled to a light-emitting device 2 below.

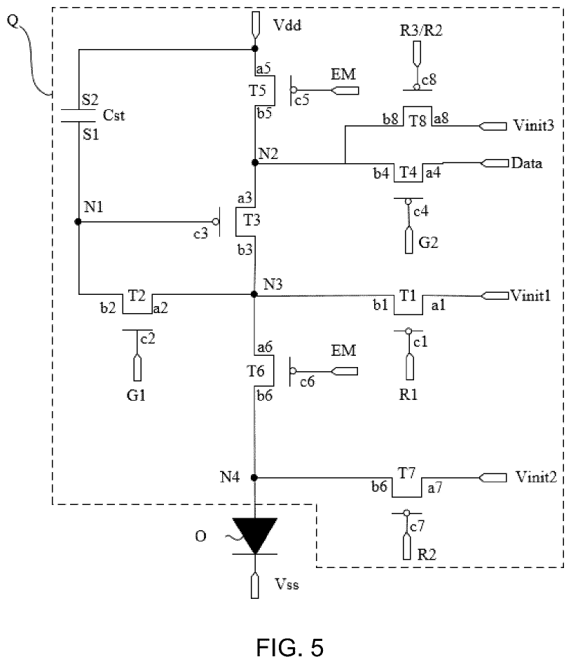

FIG. 4 is structural diagram of an array substrate, in accordance with some embodiments; FIG. 5 is an equivalent circuit diagram of a pixel driving circuit, in accordance with some embodiments.

As shown in FIG. 4, some embodiments of the present disclosure provide an array substrate 100. The array substrate 100 includes a substrate 10 and a pixel circuit layer 20 disposed on a side of the substrate 10.

In some examples, the substrate 10 may be a flexible substrate. For example, a material of the substrate 10 may be an organic material. For example, the material of the substrate 10 may be any one of polyimide (PI), polycarbonate (PC) or polyvinyl chloride (PVC).

In some examples, the substrate 10 may be a rigid substrate. For example, the rigid substrate may be a glass substrate or a polymethyl methacrylate (PMMA) substrate.

The pixel circuit layer 20 includes a plurality of metal layers that are arranged in sequence on the substrate 10. The plurality of metal layers are provided therein with the pixel driving circuits Q and a plurality of signal lines with different types. The different types of signal lines include a plurality of first scanning signal lines G1, but are not limited thereto. The different types of signal lines may further include other types of signal lines, which will be described in detail below.

The plurality of pixel driving circuits Q are located on a side of the substrate 10, and the plurality of pixel driving circuits Q are arranged in a plurality of rows and a plurality of columns. For convenience of description, in the embodiments of the present disclosure, the plurality of pixel driving circuits Q are described by taking an example in which the plurality of pixel driving circuits Q are arranged in a matrix.

In this case, pixel driving circuits Q arranged in a row in a first direction X may be referred to as a row of pixel driving circuits Q, and pixel driving circuits 100 arranged in a column in a second direction Y may be referred to as a column of pixel driving circuits Q.

In some examples, the pixel driving circuit Q includes a plurality of transistors. In some embodiments of the present disclosure, the structure of the pixel driving circuit Q may vary, and may be set according to actual needs. For example, the structure of the pixel driving circuit Q may include “2T1C”, “6T1C”, “7T1C”, “6T2C”, “7T2C” or “8T1C”. Here, “T” represents a thin film transistor, a number before “T” represents the number of thin film transistors, “C” represents a storage capacitor Cst, and a number before “C” represents the number of storage capacitors. The following will be illustrated by considering the “8T1C” pixel driving circuit as an example.

With reference to FIG. 5, the pixel driving circuit Q includes: a first reset transistor T1, a compensation transistor T2, a driving transistor T3, a data writing transistor T4, a first light-emitting control transistor T5, a second light-emitting control transistor T6, a second reset transistor T7, a third reset transistor T8 and a storage capacitor Cst.

Since the pixel driving circuit Q needs to be electrically connected to multiple different types of signal lines, the multiple different types of signal lines are also illustrated in FIG. 5. The multiple different types of signal lines may include: a first scanning signal line G1, a second scanning signal line G2, a data writing signal line Data, an enable signal line EM, a first power supply signal line Vdd, a first reset signal line R1, a second reset signal line R2, a third reset signal line R3, a first initialization signal line Vinit1, a second initialization signal line Vinit2, and a third initialization signal line Vinit3. In FIG. 5, each signal terminal is used to represent the signal line corresponding thereto.

A control electrode c1 of the first reset transistor T1 is electrically connected to the first reset signal line R1, a first electrode a1 of the first reset transistor T1 is electrically connected to the first initialization signal line Vinit1, and a second electrode b1 of the first reset transistor T1 is electrically connected to a third node N3.

In an initialization period, the first reset transistor T1 transmits, under control of a first reset signal received from the first reset signal line R1, a first initialization signal received from the first initialization signal line Vinit1 to the third node N3 to reset the third node N3, which is beneficial to ensuring the stability of the voltage of the first node N1.

A control electrode c2 of the compensation transistor T2 is electrically connected to the first scanning signal line G1, a first electrode a2 of the compensation transistor T2 is electrically connected to the third node N3, and a second electrode b2 of the compensation transistor T2 is electrically connected to the first node N1.

In a writing period, the compensation transistor T2 transmits the voltage of the third node N3 to the first node N1 under control of a first scanning signal received from the first scanning signal line G1.

In some examples, the compensation transistor T2 may be an oxide thin-film transistor. For example, the compensation transistor T2 may be an indium gallium zinc oxide (IGZO) thin film transistor.

With such the setting, it is possible to help reduce the risk of leakage of the compensation transistor T2, and it is more conducive to ensuring the stability of the voltage of the first node N1.

In some examples, the compensation transistor T2 may be an N-type transistor.

A control electrode c3 of the driving transistor T3 is electrically connected to the first node N1, a first electrode a3 of the driving transistor T3 is electrically connected to a second node N2, and a second electrode b3 of the driving transistor T3 is electrically connected to the third node N3.

The driving transistor T3 is configured to transmit the voltage of the second node N2 to the third node N3 under control of the voltage of the first node N1.

A control electrode c4 of the data writing transistor T4 is electrically connected to the second scanning signal line G2, a first electrode a4 of the data writing transistor T4 is electrically connected to the data writing signal line Data, and a second electrode b4 of the data writing transistor T4 is electrically connected to the second node N2.

In the writing period, the data writing transistor T4 transmits a data signal received from the data writing signal line Data to the second node N2 under control of the first scanning signal received from the first scanning signal line G1.

A control electrode c5 of the first light-emitting control transistor T5 is electrically connected to the enable signal line EM, a first electrode a5 of the first light-emitting control transistor T5 is electrically connected to a first power supply signal line Vdd, and a second electrode b5 of the first light-emitting control transistor T5 is electrically connected to the second node N2.

A control electrode c6 of the second light-emitting control transistor T6 is electrically connected to the enable signal line EM, a first electrode a6 of the second light-emitting control transistor T6 is electrically connected to the third node N3, and a second electrode b6 of the second light-emitting control transistor T6 is electrically connected to a fourth node N4. The fourth node N4 is electrically connected to the light-emitting device O.

The control electrode c5 of the first light-emitting control transistor T5 and the control electrode c6 of the second light-emitting control transistor T6 may be electrically connected to a same enable signal line EM. It can be understood that in some other examples, the control electrode c5 of the first light-emitting control transistor T5 is electrically connected to an enable signal line EM, and the control electrode c6 of the second light-emitting control transistor T6 may be electrically connected to another enable signal line EM, and the embodiments of the present disclosure are not limited thereto.

In a light-emitting period, the first light-emitting control transistor T5 and the second light-emitting control transistor T6 cooperate with the driving transistor T3 to transmit a driving signal to the fourth node N4 under control of an enable signal from the enable signal line EM. The fourth node N4 is electrically connected to the light-emitting device O. That is, the first light-emitting control transistor T5 and the second light-emitting control transistor T6 cooperate with the driving transistor T3 to transmit the driving signal to the light-emitting device O under the control of the enable signal from the enable signal line EM.

A control electrode c7 of the second reset transistor T7 is electrically connected to the second reset signal line R2, a first electrode a7 of the second reset transistor T7 is electrically connected to a second initial signal line Vinit2, and a second electrode b7 of the second reset transistor T7 is electrically connected to the fourth node N4. The fourth node N4 is electrically connected to the light-emitting device O.

In an initialization period, the second reset transistor T7 transmits, under control of a second reset signal received from the second reset signal line R2, a second initialization signal received from the second initialization signal line Vinit2 to the fourth node N4 to the fourth node N4 to reset the fourth node N4. Since the fourth node N4 is electrically connected to the light-emitting device O, resetting the fourth node N4 is equivalent to reset the anode of the light-emitting unit O by using the signal, which may help improve the stability of the light-emitting unit O.

In some examples, the first reset transistor T1, the driving transistor T3, the data writing transistor T4, the first light-emitting control transistor T5, the second light-emitting control transistor T6 and the second reset transistor T7 may be low temperature polysilicon oxide (LTPO) thin film transistors.

In some examples, the first reset transistor T1, the driving transistor T3, the data writing transistor T4, the first light-emitting control transistor T5, the second light-emitting control transistor T6, and the second reset transistor T7 are P-type transistors.

In addition, a first plate S1 of the storage capacitor Cst is electrically connected to the first node N1, and the second plate S2 of the storage capacitor Cst is electrically connected to the first power supply signal line Vdd.

It will be noted that each pixel driving circuit Q includes multiple transistors (TFTs), and the display speed, contrast and brightness and the resolution may be improved by using the TFT driving technology. However, the TFT has a hysteresis effect, and the hysteresis effect of TFT is an uncertainty in the electrical characteristics of TFT under a certain bias voltage. That is, the current flowing through TFT is not only related to the current bias voltage, but also to the state of TFT at the previous moment. The hysteresis effect of TFT is related to the gate dielectric of TFT, the semiconductor material and the interface stated trap between the two. During the light-emitting period, the hysteresis effect of TFT will cause a trend of current drop in a frame, which is perceived as flicker by the human eye and affects the display quality of the display panel.

Based on this, the third reset transistor T8 may be disposed in the pixel driving circuit Q. A control electrode c8 of the third reset transistor T8 is electrically connected to the third reset signal line R3, a first electrode a8 of the third reset transistor T8 is electrically connected to the third initialization signal line Vinit3, and a second electrode b8 of the third reset transistor T8 is electrically connected to the second node N2.

Under the control of the third reset signal from the third reset signal line R3, a third initialization signal from the third initialization signal line Vinit3 is transmitted to the second node N2 to initialize the second node N2. Thus, the initial state of the driving transistor T3 is fixed before the writing period, so that the driving transistor T3 is in a stable state during the writing period, and the hysteresis effect of the driving transistor T3 is greatly improved.

In some examples, the third reset transistor T8 may be a low temperature polysilicon oxide (LTPO) thin film transistor.

In some examples, the third reset transistor T8 is a P-type transistor.

In some embodiments, the third reset signal line R3 and the second reset signal line R2 may respond to a same signal line. Alternatively, it may also be understood that the second reset signal line R2 is also used as the third reset signal line R3. The following description will be made by taking an example in which the second reset signal line R2 is also used as the third reset signal line R3.

In some embodiments, the third initialization signal transmitted from the third initialization signal line Vinit3 may be a high voltage signal. Furthermore, the high voltage signal may be used to reset the second node N2, which is equivalent to resetting the first electrode a3 of the driving transistor T3, so that the initial state of the driving transistor T3 is fixed before the data writing period t2. Thus, it is convenient for the driving transistor T3 is in a stable state during the data writing period t2, which may greatly improve the hysteresis effect of the driving transistor T3.

In some examples, the first power supply signal line Vdd may also be used as the third initialization signal line Vinit3. Based on this, it is possible to simply the arrangement of all the transistors in the pixel driving circuit Q and their electrically connected signal lines, and the present disclosure does not limited thereto.

In some embodiments, the driving process of the pixel driving circuit Q with the “8T1C” structure shown in FIG. 5 is illustrated that one frame period includes an initialization period t1, a data writing period t2, an adjustment period t3 and a light-emitting period t4.

Initialization period t1: the enable signal transmitted by the enable signal line EM is a high-voltage signal. In this case, the first light-emitting control transistor T5 and the second light-emitting control transistor T6 are both in an off state. The second scanning signal transmitted by the second scanning signal line G2 is a high-voltage signal. In this case, the data writing transistor T4 is in an off state.

The first reset signal transmitted by the first reset signal line R1 includes a low-voltage signal. In this case, the first reset transistor T1 is turned on and transmits the first initialization signal transmitted by the first initialization signal line Vinit1 to the third node N3 to reset the third node N3, which is beneficial to improve the stability of the driving transistor T3 included in the pixel driving circuit Q.

The first scanning signal transmitted by the first scanning signal line G1 includes a high voltage signal, the compensation transistor T2 is turned on, and the first initialization signal transmitted by the first initialization signal line Vinit1 may be transmitted to the first node N1 through the compensation transistor T2 to reset the first node N1, which is beneficial to improve the stability of the driving transistor T3 included in the pixel driving circuit Q.

The second reset signal transmitted by the second reset signal line R2 is a low-voltage signal, the third reset transistor T8 is turned on, and transmits the third initialization signal transmitted by the third initialization signal line Vinit3 to the second node N2, which is equivalent to resetting the first electrode a3 of the driving transistor T3, so that the initial state of the driving transistor T3 before the data writing period t2 is fixed. As a result, it is beneficial to cause the driving transistor T3 to be in a stable state during the data writing period t2 and to greatly improve the hysteresis effect of the driving transistor T3.

Moreover, the second reset signal transmitted by the second reset signal line R2 is a low-voltage signal. In this case, the second reset transistor T7 is turned on and transmits the second initialization signal transmitted by the second initialization signal line Vinit2 to the fourth node N4, which is equivalent to resetting the anode of the light-emitting device O to improve the stability of the light-emitting device O.

Data writing period t2: the enable signal transmitted by the enable signal line EM is a high-voltage signal. In this case, the first light-emitting control transistor T5 and the second light-emitting control transistor T6 are both in an off state. The first reset signal transmitted by the first reset signal line R1 is a high-voltage signal, and in this case, the first reset transistor T1 is in an off state. The second reset signal transmitted by the second reset signal line R2 is a high-voltage signal, and in this case, the second reset transistor T7 and the third reset transistor T8 are all in an off state.

The first scanning signal transmitted by the first scanning signal line G1 includes a high-voltage signal, and the compensation transistor T2 is turned on. Moreover, the second scanning signal transmitted by the second scanning signal line G2 is a low-voltage signal. In this case, the data writing transistor T4 is turned on, and the data writing signal transmitted by the data writing signal line Data may be transmitted to the first node N1 via the data writing transistor T4, the driving transistor T3 and the compensation transistor T2 sequentially to compensate the first node N1, so that the potential of the first node N1 is gradually increased to Vdata+Vth, where Vdata is a voltage value of the data writing signal provided by the data writing signal line Data, and Vth is a threshold voltage of the driving transistor T3 in the pixel driving circuit Q. In a case where the potential of the first node N1 is Vdata+Vth, the charging process is completed. Subsequently, the driving transistor T3 included in the pixel driving circuit Q is kept to be continuously turned on by using the discharging of the storage capacitor Cst, which ensures that the light-emitting device O emits light.

Adjustment period t3: the enable signal transmitted by the enable signal line EM is a high-voltage signal. In this case, the first light-emitting control transistor T5 and the second light-emitting control transistor T6 are both in an off state. The second scanning signal transmitted by the second scanning signal line G2 is a high-voltage signal, and in this case, the data writing transistor T4 is in an off state. The first scanning signal provided by the first scanning signal line G1 is a low-voltage signal, and in this case, the compensation transistor T2 is in an off state. The first reset signal provided by the first reset signal line R1 is a high-voltage signal, and the first reset transistor T1 is in an off state.

The second reset signal transmitted by the second reset signal line R2 includes a low-voltage signal. The third reset transistor T8 is turned on and transmits the third initialization signal transmitted by the third initialization signal line Vinit3 to the second node N2, which is equivalent to resetting the first electrode a3 of the driving transistor T3, so that the initial state of the driving transistor T3 is fixed before the data writing stage t2. Thus, it is convenient for the driving transistor T3 is in a stable state during the data writing period t2, which may greatly improve the hysteresis effect of the driving transistor T3.

Moreover, the second reset signal transmitted by the second reset signal line R2 is a low-voltage signal. In this case, the second reset transistor T7 is turned on and transmits the second initialization signal transmitted by the second initialization signal line Vinit2 to the fourth node N4, which is equivalent to resetting the anode of the light-emitting unit O to improve the stability of the light-emitting unit O.

Light-emitting period t4: the first scanning signal provided by the first scanning signal line G1 is a low-voltage signal, and in this case, the compensation transistor T2 is in an off state. The first reset signal provided by the first reset signal terminal R1 is a high-voltage signal, and in this case, the first reset transistor T1 is in an off state. The second scanning signal transmitted by the second scanning signal line G2 is a high-voltage signal, and in this case, the data writing transistor T4 is in an off state. The second reset signal transmitted by the second reset signal line R2 is a high-voltage signal, and in this case, the second reset transistor T7 and the third reset transistor T8 are both in an off state.

Moreover, the enable signal transmitted by the enable signal line EM is a low-voltage signal. In this case, both the first light-emitting control transistor T5 and the second light-emitting control transistor T6 are both turned on. In this case, the driving transistor T3 included in the pixel driving circuit Q may be kept turned on by using the discharging of the storage capacitor Cst. Based on this, a constant voltage power supply signal provided by the first power signal line Vdd may flow to the anode of the light-emitting device O via the first light-emitting control transistor T5, the driving transistor T3, and the second light-emitting control transistor T6 in sequence, and the cathode of the light-emitting device O may be electrically connected to a second power supply signal line Vss, thereby driving the light-emitting device O to emit light. The first power supply signal line Vdd may be a high power supply signal line, and the second power supply signal line Vss may be a low power supply signal line.

The effective signal of the first scanning signal transmitted by the first scanning signal line G1 is inverted with the effective signal of the second scanning signal transmitted by the second scanning signal line G2.

The term “effective signal” refers to a signal that enables a transistor electrically connected thereto to be turned on. For example, the first scanning signal line G1 is electrically connected to a P-type transistor, and the effective signal is a low-voltage signal. Alternatively, the first scanning signal line G1 is electrically connected to an N-type transistor, and the effective signal is a high-voltage signal. The same is true for the second scanning signal line G2.

It will be noted that the N-type transistor is turned on when the gate receives a high-voltage signal, while the P-type transistor is turned on when the gate receives a low-voltage signal. It will be noted that the “high-voltage signal” and “low-voltage signal” mentioned above are popular terms. In generally, the condition of turning on an N-type transistor is that a gate-source voltage difference is greater than the threshold voltage thereof, that is, the gate voltage of the N-type transistor is greater than a sum of the source voltage thereof and the threshold voltage thereof, and the threshold voltage of the N-type transistor is positive, then the gate voltage signal that turns on the N-type transistor is referred to as a high voltage signal. The condition of turning on a P-type transistor is that an absolute value of the gate-source voltage difference is greater than the threshold voltage thereof; the threshold voltage of the P-type transistor is negative; that is, the gate voltage of the P-type transistor is less than a sum of the source voltage thereof and the threshold voltage thereof, then the gate voltage signal that turns on the P-type transistor is referred to as a low-voltage signal. The voltage of the “high-voltage signal” is greater than the voltage of the “low-voltage signal”.

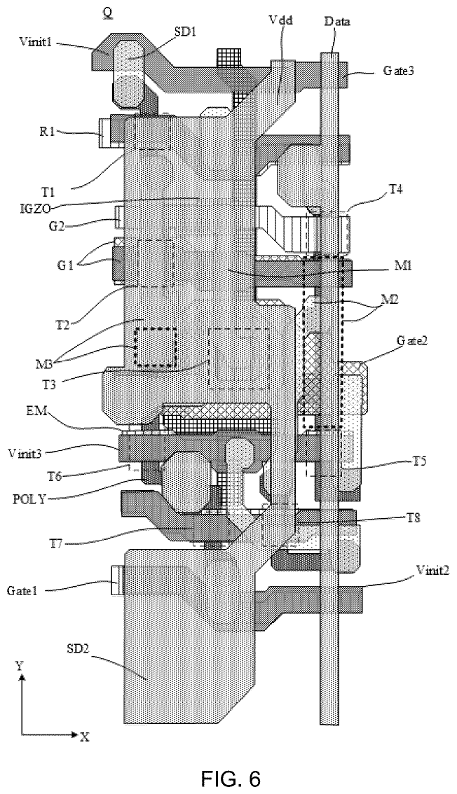

FIG. 6 is a structural diagram of a pixel driving circuit, in accordance with some implementations.

In some embodiments, with reference to FIGS. 5 and 6, any pixel driving circuit Q in the array substrate 100 further includes a first conductive connection portion M1. The first conductive connection portion M1 is electrically connected to the control electrode c3 of the driving transistor T3, and the first conductive connection portion M1 is electrically connected to the second electrode b1 of the compensation transistor T2. In addition, the first conductive connection portion M1 is further electrically connected to the storage capacitor Cst.

In some examples, any pixel driving circuit Q in the array substrate 100 further includes a second conductive connection portion M2 and a third conductive connection portion M3. The second conductive connection portion M2 is electrically connected to the first electrode a3 of the driving transistor T3. In addition, the second conductive connection portion M2 is further electrically connected to the second electrode b4 of the data writing transistor T4, the second electrode b5 of the first light-emitting control transistor T5, and the second electrode b8 of the third reset transistor T8. The third conductive connection portion M3 is electrically connected to the second electrode b3 of the driving transistor T3, and the third conductive connection portion M3 is electrically connected to the first electrode a2 of the compensation transistor T2. In addition, the third conductive connection portion M3 is further electrically connected to the second electrode b1 of the first reset transistor T1, and the third conductive connection portion M3 is further electrically connected to the first electrode a6 of the second light-emitting control transistor T6.

It will be noted that, as shown in FIGS. 4 and 5, the first conductive connection portion M1 may be the first node N1 in the equivalent circuit diagram of the pixel driving circuit Q, the second conductive connection portion M2 may be the second node N2 in the equivalent circuit diagram of the pixel driving circuit Q, and the third conductive connection portion M3 may be the third node N3 in the equivalent circuit diagram of the pixel driving circuit Q.

It has been found through research that since the pixel driving circuit Q includes 8 transistors and other structures, and the layout of the pixel driving circuit Q is relatively compact, which will lead to a case that orthographic projections of multiple different types of signal lines electrically connected to the pixel driving circuit Q on the substrate 10 is easy to overlap with orthographic projections of all the transistors in the pixel driving circuit Q on the substrate 10.

Referring to FIG. 6, the multiple different types of signal lines include a plurality of first scanning signal lines G1 extending in a first direction X and arranged in a second direction Y; the second direction Y and the first direction X intersect.

For example, the first direction X is perpendicular to the second direction Y. It can be understood that, in some other embodiments, the first direction X and the second direction Y intersect to form a first included angle, and the first included angle may be an acute angle or an obtuse angle.

The orthographic projection of the first scanning signal line G1 on the substrate 10 overlaps with each of orthographic projections of the first conductive connection portion M1, the second conductive connection portion M2 and the third conductive connection portion M3 in the pixel driving circuit Q on the substrate 10.

With the above structure, the parasitic capacitance will be generated between the first scanning signal line G1 and the first conductive connection portion M1, between the first scanning signal line G1 and the second conductive connection portion M2, and between the first scanning signal line G1 and the third conductive connection portion M3. Furthermore, in a case where the first scanning signal line G1 is used to transmit the first scanning signal, the jump in the potential of the first scanning signal will cause the potentials of the first conductive connection portion M1, the second conductive connection portion M2 and the third conductive connection portion M3 to jump accordingly. Moreover, during the data writing period, the potentials of the first conductive connection portion M1, the second conductive connection portion M2, and the third conductive connection portion M3 all jump as the writing of the data writing signal from the data writing signal line Data. In this case, the jump in the potentials of the first conductive connection portion M1, the second conductive connection portion M2, and the third conductive connection portion M3 will also cause the jump in the potential of the first scanning signal.

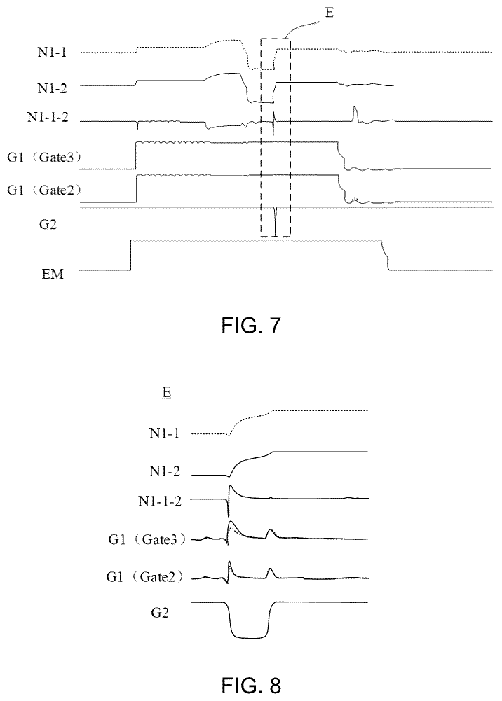

As shown in FIG. 7, FIG. 7 is a timing diagram of the first node, the first scanning signal line, the second scanning signal line, and the enable signal line in the pixel driving circuit, in accordance with some embodiments, and FIG. 8 is a partial enlarged view of the region E in FIG. 7. N1-1 and N1-2 each represent the potential of the first node N1 (first conductive connection portion M1); N1-1-2 represents the waveform formed after the difference is made between N1-1 and N1-2; G1 (Gate3) represents the first scanning signal line G1 formed in a third gate metal layer Gate3; and G1 (Gate2) represents the first scanning signal line G1 formed in a second gate metal layer Gate2.

In a case where the first scanning signal provided by the first scanning signal line G1 is increased to a high-voltage signal, the first scanning signal may control the compensation transistor T2 to be turned on. In this case, the first scanning signal transmitted by the first scanning signal line will pull the voltages of the first conductive connection portion M1, the second conductive connection portion M2, and the third conductive connection portion M3.

In a case where the second scanning signal provided by the second scanning signal line G2 drops to a low-voltage signal, the second scanning signal may control the data writing transistor T4 to be turned on, and the data writing signal transmitted by the data writing signal line Data is sequentially written to the second conductive connection portion M2, the third conductive connection portion M3 and the first conductive connection portion M1 (the control electrode c3 of the driving transistor T3), and in this case, the potentials of the second conductive connection portion M2, the third conductive connection portion M3 and the first conductive connection portion M1 will be pulled high by the data writing signal. Moreover, in a case where the potentials of the second conductive connection portion M2, the third conductive connection portion M3 and the first conductive connection portion M1 are increased, the potential of the first scanning signal transmitted by the first scanning signal line G1 will be increased.

In addition, in the related art, since one first scanning signal line G1 is electrically connected to a row of pixel driving circuits Q, a parasitic capacitance may be formed between the first scanning signal line G1 and the first conductive connection portions M1 of the pixel driving circuits Q in the row. Furthermore, the first scanning signal line G1 also affects the voltage of the first node N1 in the pixel driving circuit Q adjacent to a pixel driving circuit Q in the first direction X (a row direction), and the voltage of the first node N1 will affect the degree of turning on of the driving transistor T3, which will in turn affect the luminance of the light-emitting device O. This phenomenon may be referred to as lateral crosstalk deterioration.

That is, since a first scanning signal line G1 is electrically connected to a row of pixel driving circuits Q, at least one pixel driving circuit Q adjacent to a certain target pixel driving circuit Q drives the corresponding light-emitting device to emit light at different luminance when displaying images in two adjacent frames, which will cause different degree of mutual pulling for the potentials of the first scanning signal line G1 and the first conductive connection portions M1, second conductive connection portions M2 and third conductive connection portions M3 of the pixel driving circuits Q in the row when displaying two adjacent frames, so that the opening degree of the driving transistor T3 of the target pixel driving circuit Q will be affected, and cannot drive the light-emitting device O to emit light at the target luminance.

Specifically, the description will be made by considering three pixel driving circuits Q arranged sequentially in the first direction X as an example.

With continued reference to FIGS. 7 and 8, the dotted lines in FIGS. 7 and 8 represent the timing diagram corresponding to the previous frame, and the solid lines represent the timing diagram of the next frame. In the previous frame, all the pixel driving circuits display the same brightness (white image); in the next frame, one pixel drive circuit displays the previous luminance (white image), and two pixel drive circuits adjacent to the one pixel drive circuit display another luminance (black image).

The three pixel driving circuits Q are respectively a first pixel driving circuit, a second pixel driving circuit and a third pixel driving circuit, and the second pixel driving circuit is located between the first pixel driving circuit and the third pixel driving circuit in the first direction X.

In the previous frame of two adjacent frames, the first pixel driving circuit, the second pixel driving circuit and the third pixel driving circuit are driven to enable the light-emitting devices O corresponding electrically connected to the first pixel driving circuit, the second pixel driving circuit and the third pixel driving circuit to emit a same first luminance. For example, the first luminance may be the luminance corresponding to the white image displayed on the display panel.

In the latter frame of the two adjacent frames, the first pixel drive circuit, the second pixel drive circuit and the third pixel drive circuit are driven to enable the light-emitting devices O corresponding electrically connected to the first pixel drive circuit and the third pixel drive circuit to emit a same second luminance. For example, the second luminance may be the luminance corresponding to the black image displayed on the display panel.

In this case, the same electrical signal (the signal output to the second pixel driving circuit in the previous frame) is still provided. Ideally, the second pixel driving circuit may drive the corresponding light-emitting device O to emit the first luminance.

However, since the first luminance is greater than the second luminance, the voltage value of the required data writing signal corresponding to the first luminance is greater than the voltage value of the required data writing signal corresponding to the second luminance. Based on this, the degree to which the first conductive connection portion M1, the second conductive connection portion M2 and the third conductive connection portion M3 pull up the potential of the first scanning signal line G1 during the data writing period corresponding to the first luminance is greater than the degree to which the first conductive connection portion M1, the second conductive connection portion M2 and the third conductive connection portion M3 pull up the potential of the first scanning signal line G1 during the data writing period corresponding to the second luminance. Accordingly, it will cause the potential of the first scanning signal line G1 to decrease more to cause the compensation transistor T2 to be turned off.

However, in the process of turning off the compensation transistor T2, i.e., the process of the potential of the first scanning signal line G1 decreasing, the degree of decrease in the potential of the first conductive connection portion M1, the second conductive connection portion M2 and the third conductive connection portion M3 at the first luminance is more severe than the degree of decrease in the potential of the first conductive connection portion M1, the second conductive connection portion M2 and the third conductive connection portion M3 at the second luminance. Furthermore, in two adjacent frames, the potential of the control electrode c3 of the driving transistor T3 decreases in different degrees, that is, the driving transistor T3 is turned on in different degrees, which in turn affects the luminance of the light-emitting device O. That is, when displaying the next frame, even if the data writing signal required for the first luminance is provided to the second pixel driving circuit, due to the different opening degree of the driving transistor T3, it will cause the light-emitting device O electrically connected to the second pixel driving circuit cannot emit the first luminance (for example, due to the relative decrease in the potential of the control electrode c3 of the driving transistor T3, the driving transistor T3 will be turned on to a great extent, which may cause the luminance of the light-emitting device O to be to be greater than the first luminance).

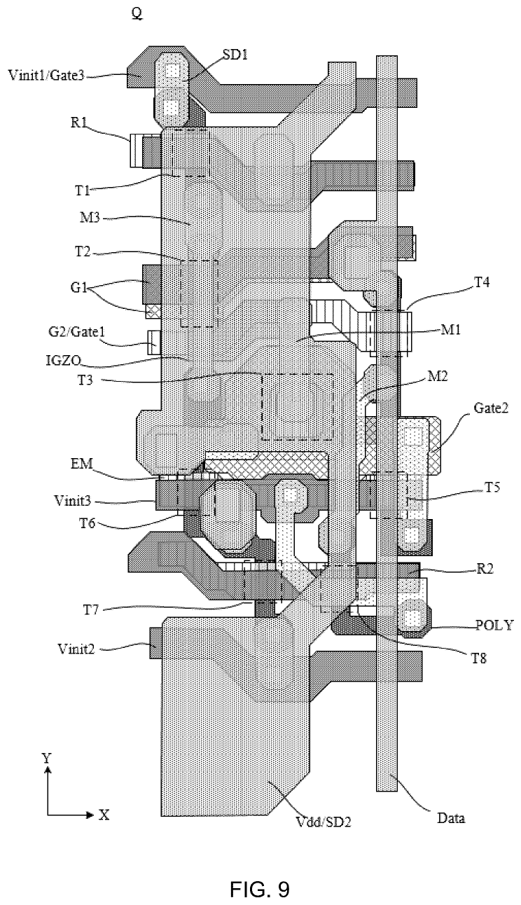

FIG. 9 is a structural diagram of a pixel driving circuit, in accordance with some embodiments.

Based on the above problems, some embodiments of the present disclosure provide an array substrate 100. Referring to FIGS. 9 and 5, the pixel driving circuit Q in the array substrate 100 includes: a compensation transistor T2, a driving transistor T3, a first conductive connection portion M1, a second conductive connection portion M2, and a third conductive connection portion M3.

It will be noted that the equivalent circuit diagram corresponding to the pixel driving circuit Q shown in FIG. 9 is consistent with the equivalent circuit diagram corresponding to the pixel driving circuit Q shown in FIG. 6, but the layout of the pixel driving circuit Q is not consistent. For example, the positions of the first scanning signal line G1 and other transistors may be adjusted, so that an orthographic projection of the first scanning signal line G1 on the substrate 10 is non-overlapping with an orthographic projection of the first conductive connection portion M1 on the substrate 10.

Based on this, it is possible to prevent a parasitic capacitance is generated between the first scanning signal line G1 and the first conductive connection portion M1 in the corresponding pixel driving circuit Q, thereby ameliorating the problem of potential jump caused by mutual induction between the first scanning signal line G1 and the first conductive connection portion M1. Therefore, it may be beneficial to improve the stability of the driving transistor T3 (the control electrode c3 of the driving transistor T3), so that the problem of lateral crosstalk deterioration may be ameliorated.

With the above arrangement, by adjusting the pixel driving circuit Q to set the orthographic projection of the first scanning signal line G1 on the substrate 10 is non-overlapping with the orthographic projection of the first conductive connection portion M1 on the substrate 10, it is possible to prevent the potential of the first conductive connection portion M1 from jumping in the data writing period to pull the potential of the first scanning signal transmitted on the first scanning signal line G1; moreover, it is possible to prevent the first scanning signal transmitted on the first scanning signal line G1 from pulling down the potential of the first conductive connection portion M1 during the light-emitting period, i.e., a process in which the potential of the first scanning signal transmitted on the first scanning signal line G1 needs to decrease to enable the compensation transistor T2 to be turned off. Therefore, the stability of the potentials of the first conductive connection portion M1 and the first scanning signal line G1 may be improved, and the stability of the driving transistor T3 may also be improved, which may help ameliorate the problem of lateral crosstalk deterioration.

To sum up, some embodiments of the present disclosure provide an array substrate 100. By adjusting the layout of the pixel driving circuit Q in the array substrate 100, the orthographic projection of the first scanning signal line G1 on the substrate 10 is prevented from overlapping with the orthographic projection of the first conductive connection portion M1 on the substrate 10 as much as possible. Due to the connection relationship between all the transistors and the connection relationship between the first scanning signal line G1 and the compensation transistor T2, the orthographic projection of the first scanning signal line G1 on the substrate 10 may be non-overlapping with the orthographic projection of the first conductive connection portion M1 on the substrate 10, so as to reduce the degree of overlapping between the driving transistor T3 and the first scanning signal line G1, and improve the stability of the driving transistor T3, and thereby help ameliorate the problem of lateral crosstalk deterioration.

In some embodiments, as shown in FIG. 9, an orthographic projection of the first scanning signal line G1 on the substrate 10 is non-overlapping with the orthographic projections of the second conductive portion M2 on the substrate 10.

Based on this, it is possible to prevent a parasitic capacitance is generated between the first scanning signal line G1 and the second conductive connection portion M2 corresponding to the first scanning signal line G1 in the pixel driving circuit Q, thereby ameliorating the problem of potential jump caused by mutual induction between the first scanning signal line G1 and the second conductive connection portion M2. Therefore, it may be possible to help improve the stability of the driving transistor T3 (the first electrode a3 of the driving transistor T3), and avoid the problem of potential instability of the control electrode c3 of the driving transistor T3 due to the gate-source capacitive coupling, and thereby help ameliorate the problem of lateral crosstalk deterioration.

With the above arrangement, by adjusting the pixel driving circuit Q to set the orthographic projection of the first scanning signal line G1 on the substrate 10 is non-overlapping with the orthographic projection of the second conductive connection portion M2 on the substrate 10, it is possible to prevent the potential of the second conductive connection portion M2 from jumping in the data writing period to pull the potential of the first scanning signal transmitted on the first scanning signal line G1; moreover, it is possible to prevent the first scanning signal transmitted on the first scanning signal line G1 from pulling down the potential of the second conductive connection portion M2 during the light-emitting period, i.e., a process in which the potential of the first scanning signal transmitted on the first scanning signal line G1 needs to decrease to enable the compensation transistor T2 to be turned off. Therefore, the stability of the potentials of the second conductive connection portion M2 and the first scanning signal line G1 may be improved to improve the stability of the driving transistor T3 (the first electrode a3 of the driving transistor T3) and prevent the problem of potential instability of the control electrode c3 of the driving transistor T3 due to the gate-source capacitive coupling, thereby helping ameliorate the problem of lateral crosstalk deterioration.

In some embodiments, referring to FIG. 9, the orthographic projection of the first scanning signal line G1 on the substrate 10 is non-overlapping with the orthographic projection of the first conductive connection portion M1 on the substrate 10, and the orthographic projection of the first scanning signal line G1 on the substrate 10 is non-overlapping with the orthographic projection of the second conductive connection portion M2 on the substrate 10. Based on this, it is possible to prevent a parasitic capacitance is generated between the first scanning signal line G1 and the first conductive connection portion M1 and second conductive connection portion M2 in the corresponding pixel driving circuit Q, thereby ameliorating the problem of potential jump caused by mutual induction between the first scanning signal line G1 and the first conductive connection portion M1 and second conductive connection portion M2. Therefore, it may be possible to help improve the stability of the driving transistor T3, and thereby ameliorate the problem of worsening crosstalk.

With the above arrangement, by adjusting the pixel driving circuit Q to set the orthographic projection of the first scanning signal line G1 on the substrate 10 is non-overlapping with the orthographic projection of the second conductive connection portion M2 on the substrate 10, it is possible to prevent the potential of the second conductive connection portion M2 from jumping in the data writing period to pull the potential of the first scanning signal transmitted on the first scanning signal line G1; moreover, it is possible to prevent the first scanning signal transmitted on the first scanning signal line G1 from pulling down the potential of the second conductive connection portion M2 during the light-emitting period, i.e., a process in which the potential of the first scanning signal transmitted on the first scanning signal line G1 needs to decrease to enable the compensation transistor T2 to be turned off. Therefore, the stability of the potentials of the second conductive connection portion M2 and the first scanning signal line G1 may be improved to improve the stability of the driving transistor T3, which may help to ameliorate the problem of lateral crosstalk deterioration.

To sum up, some embodiments of the present disclosure provide an array substrate 100. By adjusting the layout of the pixel driving circuit Q in the array substrate 100, the orthographic projection of the first scanning signal line G1 on the substrate 10 is prevented from overlapping with the orthographic projections of the first conductive connection portion M1, the second conductive connection portion M3, and the conductive connection portion M3 on the substrate 10 as much as possible. Due to the connection relationship between all the transistors and the connection relationship between the first scanning signal line G1 and the compensation transistor T2, the orthographic projection of the first scanning signal line G1 on the substrate 10 is non-overlapping with the orthographic projection of the first conductive connection portion M1 on the substrate 10, and/or the orthographic projection of the first scanning signal line G1 on the substrate 10 is non-overlapping with the orthographic projection of the second conductive connection portion M2 on the substrate 10, so that the degree of overlapping between the driving transistor T3 and the first scanning signal line G1 is reduced and the stability of the driving transistor T3 is improved, which may help ameliorate the problem of lateral crosstalk deterioration.

The overlapping relationship between the driving transistor T3 and the first scanning signal line G1 in the array substrate 100 is described above with reference to the accompanying drawings. On this basis, the following will describe the distribution of the film layers of the multiple transistors and various signal lines in the array substrate 100 in detail with reference to the relevant drawings.

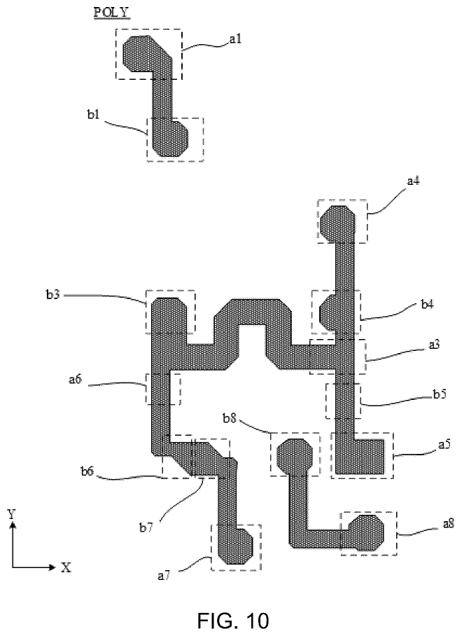

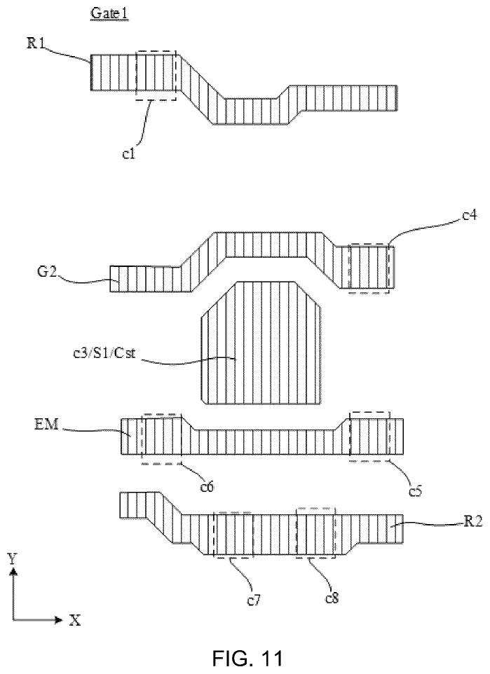

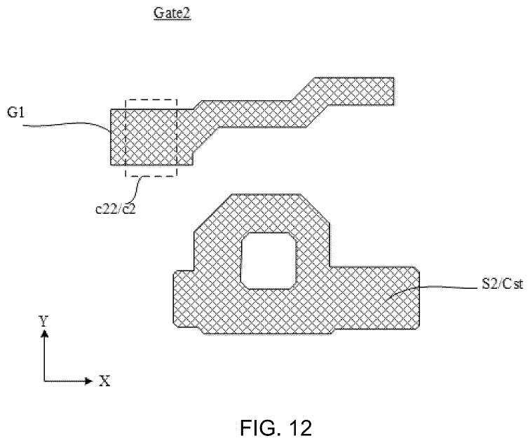

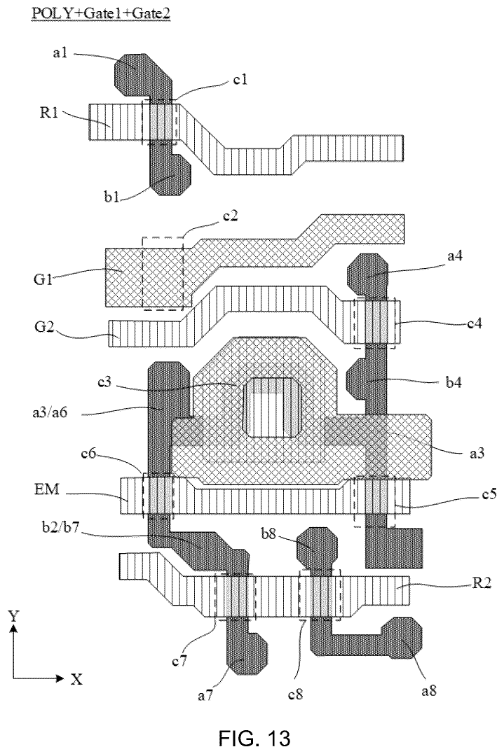

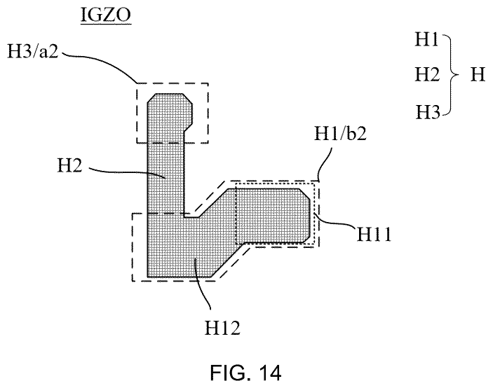

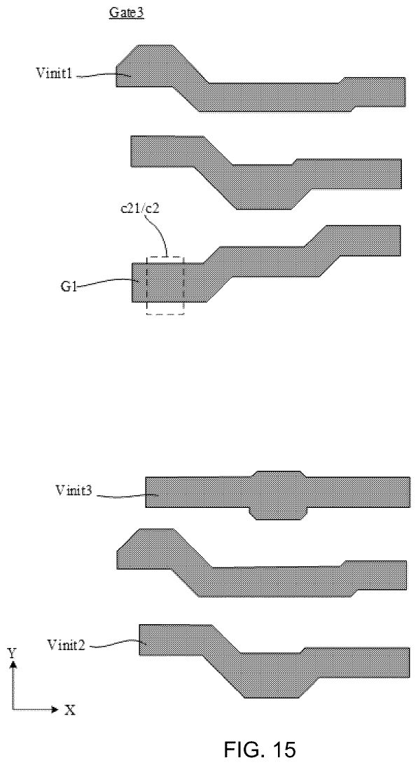

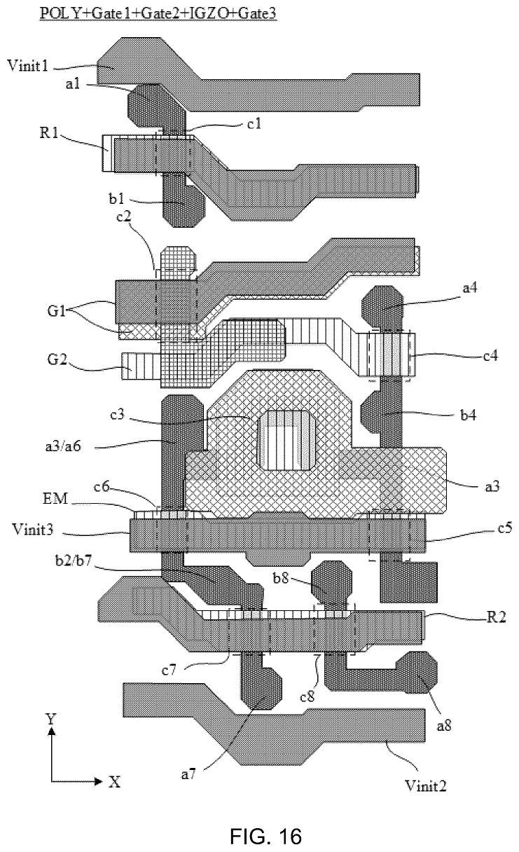

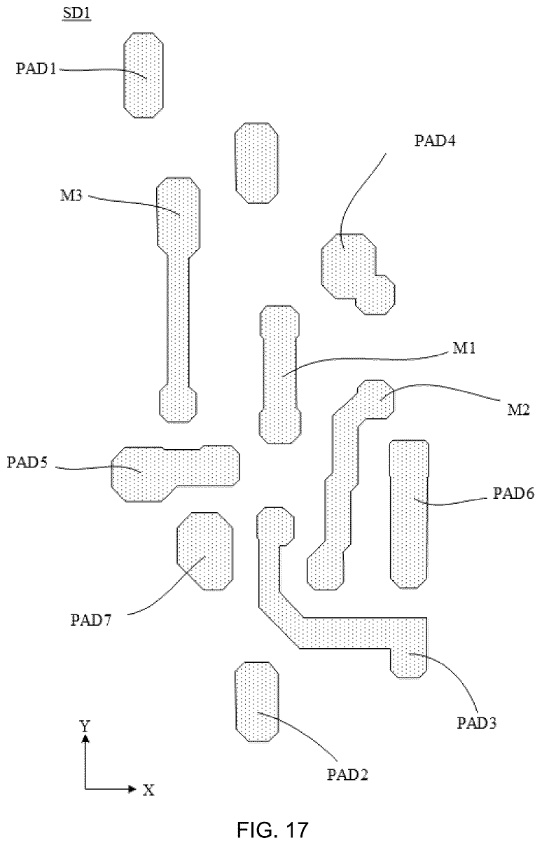

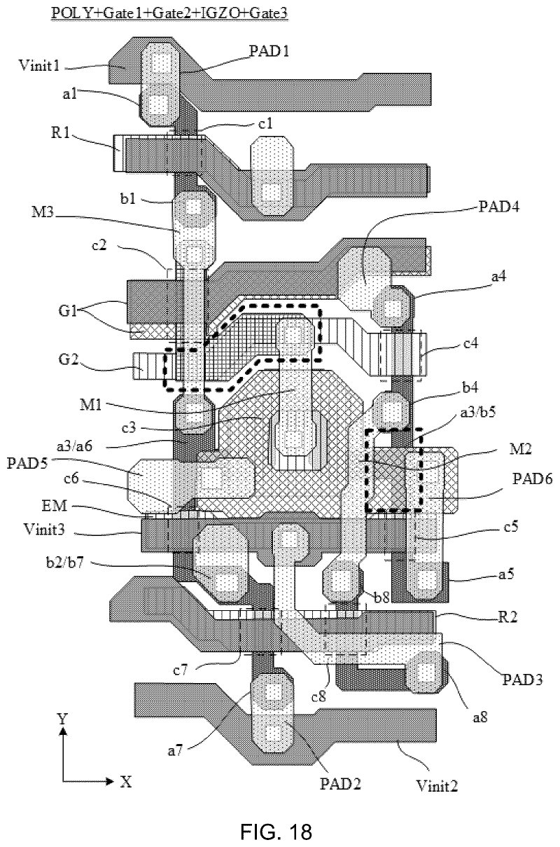

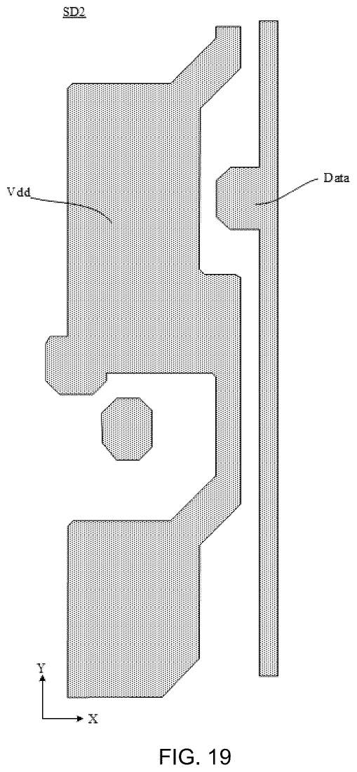

FIG. 10 is a structural diagram of a first semiconductor layer in FIG. 9, FIG. 11 is a structural diagram of a first gate metal layer in FIG. 9, FIG. 12 is a structural diagram of a second gate metal layer in FIG. 9, FIG. 13 is a structural diagram of some film layers in FIG. 9, FIG. 14 is a structural diagram of a second semiconductor layer in FIG. 9, FIG. 15 is a structural diagram of a third gate metal layer in FIG. 9, FIG. 16 is a structural diagram of some other film layers in FIG. 9, FIG. 17 is a structural diagram of a first wiring metal layer in FIG. 9, FIG. 18 is a structural diagram of yet some other film layers in FIG. 9, and FIG. 19 is a structural diagram of a second wiring metal layer in FIG. 9.

In some embodiments, as shown in FIG. 4, and FIGS. 9 to 19, the array substrate 100 includes a substrate and a pixel driving circuit layer 20 disposed on the substrate 10. The pixel driving circuits Q and a plurality of different types of signal lines are disposed in the multiple layers in the pixel circuit layer 20. The multiple layers in the pixel circuit layer 20 include: a first semiconductor layer POLY, a first gate metal layer Gate1, a second gate metal layer Gate2, a second semiconductor layer IGZO, a third gate metal layer Gate3, a first wiring metal layer SD1 and a second wiring metal layer SD2.

As shown in FIGS. 9 and 10, the first semiconductor layer POLY is located on the substrate 10. The first semiconductor layer POLY includes the first electrode a3 of the driving transistor T3 and the second electrode b3 of the driving transistor T3.

In addition, the first semiconductor layer POLY further includes the first electrodes and second electrodes of the six transistors: the first reset transistor T1, the data writing transistor T4, the first light-emitting control transistor T5, the second light-emitting control transistor T6, the second reset transistor T7 and the third reset transistor T8.

A material of the first semiconductor layer POLY includes a semiconductor material of amorphous silicon, single crystal silicon, or polycrystalline silicon.

As shown in FIGS. 9 and 11, the first gate metal layer Gate1 is located on a side of the first semiconductor layer POLY away from the substrate 10 (as shown in FIG. 4). The first gate metal layer Gate1 includes the control electrode c3 of the driving transistor T3.

In addition, the first gate metal layer Gate1 further includes the control electrodes of the 6 transistors: the first reset transistor T1, the data writing transistor T4, the first light-emitting control transistor T5, the second light-emitting control transistor T6, the second reset transistor T7 and the third reset transistor T8.

A material of the first gate conductive layer Gate1 includes a conductive metal. For example, the conductive metal includes at least one of aluminum, copper, or molybdenum, and the present disclosure is not limited thereto.

For example, a first gate insulating layer is provided between the first semiconductor layer POLY and the first gate metal layer Gate1, and the first semiconductor layer POLY is electrically insulated from the first gate metal layer Gate1 through the first gate insulating layer.

A material of the first gate insulating layer includes any of inorganic insulating materials of silicon nitride, silicon oxynitride and silicon oxide. For example, the material of the first gate insulating layer includes silicon dioxide, and the present disclosure is not limited thereto.

In addition, the first gate metal layer Gate1 may also be used to form part of the signal lines, which include the first reset signal line R1, the enable signal line EM, the second scanning signal line G2, and the second reset signal line R2.

In some examples, the first gate metal layer Gate1 may include a plurality of second scanning signal lines G2 extending in the first direction X and arranged in the second direction Y. A second scanning signal line G2 is electrically connected to a row of pixel driving circuits Q. As shown in FIG. 11, the second scanning signal line G2 may include a first portion, and the first portion of the second scanning signal line G2 may also be used as the control electrode c4 of the data writing transistor T4.

In some examples, the first gate metal layer Gate1 may include a plurality of first reset signal lines R1 extending in the first direction X and arranged in the second direction Y. As shown in FIG. 11, the first reset signal line R1 may include a first portion, and the first portion of the first reset signal line R1 may also be used as the control electrode c1 of the first reset transistor T1.

In some examples, as shown in FIG. 11, the second reset signal line R2 located in the first gate metal layer Gate1 may include a first portion, and the first portion of the second reset signal line R2 may also be used as the control electrode c7 of the second reset transistor T7. It can be understood that, in some other embodiments, as shown in FIG. 11, in a case where the second reset signal line R2 may also be used as the third reset signal line R3, the second reset signal line R2 further includes a second portion spaced apart from the first portion, and the second portion of the second reset signal line R2 is also used as the control electrode c8 of the third reset transistor T8.

In some examples, the first gate metal layer Gate1 may include a plurality of enable signal lines EM extending in the first direction X and arranged in the second direction Y. The enable signal line EM may include a first portion and a second portion arranged at intervals; as shown in FIG. 11, the first portion of the enable signal line EM may also be used as the control electrode c5 of the first light-emitting control transistor T5, and the second portion of the enable signal line EM may also be used as the control electrode c6 of the second light-emitting control transistor T6.

It will be noted that, as shown in FIG. 13, an orthographic projection of the first semiconductor layer POLY on the substrate 10 (as shown in FIG. 4) overlaps with an orthographic projection of the first gate metal layer Gate1 on the substrate 10. Portions of the first semiconductor layer POLY covered by the first gate metal layer Gate1 form the channel portions of all the transistors, and portions of the first semiconductor layer POLY not covered by the first gate metal layer G1 are conductive portions and form a part of the first electrodes or second electrodes of all the transistors.

In addition, in some examples, the first gate metal layer Gate1 further includes a first plate S1 of the storage capacitor Cst, and the first plate S1 of the storage capacitor Cst may also be used as the control electrode c3 of the driving transistor T3.

Based on this, there is no need to set up a control electrode c3 of the driving transistor T3 additionally, which may help simplify the manufacturing process of the pixel driving circuit Q. Moreover, the first plate S1 of the storage capacitor Cst may also be used as the control electrode c3 of the driving transistor T3, so that the first plate S1 of the storage capacitor Cst is directly electrically connected to the control electrode c3 of the driving transistor T3 without the need for providing a connection portion additionally, which may also be beneficial to the layout of the pixel driving circuit Q.

As shown in FIG. 9 and FIG. 12, the second gate metal layer Gate2 is located on a side of the first gate metal layer Gate1 away from the first semiconductor layer POLY.

For example, a material of the second gate metal layer Gate2 is the same as the material of the first gate metal layer Gate1. It can be understood that in some other examples, the material of the second gate metal layer Gate2 is different from the first gate metal layer Gate1, and the embodiments of the present disclosure are not limited thereto.

A second interlayer insulating layer is provided between the second gate metal layer Gate2 and the first gate metal layer Gate1, so that the second gate metal layer Gate2 is insulated from the first gate metal layer Gate1 through the second interlayer insulating layer.

For example, a material of the second gate insulating layer includes any of inorganic insulating materials of silicon nitride, silicon oxynitride and silicon oxide. The material of the second gate insulating layer may include silicon dioxide, and the present disclosure is not limited thereto.

In some embodiments, as shown in FIGS. 12 and 13, the second gate metal layer Gate2 includes the second plate S2 of the storage capacitor Cst, an orthographic projection of the first plate S1 of the storage capacitor Cst on the substrate 10 (as shown in FIG. 4) at least partially overlaps with an orthographic projection of the second plate S2 of the storage capacitor Cst on the substrate 10 to form the storage capacitor Cst. The second plate S2 of the storage capacitor Cst is electrically connected to the first power supply signal line Vdd.

In addition, the second gate metal layer Gate2 may also be used to form a part of the signal lines, and the part of the signal lines includes the first scanning signal line G1.

In some examples, the first scanning signal line G1 located in the second gate metal layer Gate2 may include a first portion, and the first portion of the first scanning signal line G1 may also be used as the control electrode c2 of the compensation transistor T2.

As shown in FIGS. 9 and 14, the second semiconductor layer IGZO is located on a side of the second gate metal layer Gate2 away from the first gate metal layer Gate1. The second semiconductor layer IGZO includes the first electrode a2 of the compensation transistor T2 and the second electrode b2 of the compensation transistor T2.

As shown in FIGS. 9 and 15, the third gate metal layer Gate3 is located on a side of the second semiconductor layer IGZO away from the second gate metal layer Gate2. The third gate metal layer Gate3 may further include a plurality of first scanning signal lines G1 extending in the first direction X and arranged in the second direction Y.

It will be noted that the compensation transistor T2 may be an oxide thin film transistor, and the compensation transistor T2 may be of a dual gate structure. The control electrode c2 of the compensation transistor T2 includes a top gate c21 (as shown in FIG. 15) of the compensation transistor T2 and a bottom gate c22 (as shown in FIG. 12) of the compensation transistor T2.

Based on this, the first portion of the first scanning signal line G1 located in the second gate metal layer Gate2 may also be used as the bottom gate c22 of the compensation transistor T2. The first scanning signal line G1 located in the third gate metal layer Gate3 may include a second portion, and the first scanning signal line G1 may include a second portion also used as the top gate c21 of the compensation transistor T2.

In addition, the third gate metal layer Gate3 may further include a first initialization signal line Vinit1, a second initialization signal line Vinit2, and a third initialization signal line Vinit3 extending in the first direction X and arranged in the second direction Y.

As shown in FIGS. 9 and 17, the first wiring metal layer SD1 is located on a side of the third gate metal layer Gate3 away from the second gate metal layer Gate2. The first wiring metal layer SD1 may be used to form the first conductive connection portion M1, the second conductive connection portion M2 and the third conductive connection portion M3.

In addition, as shown in FIG. 17, the first wiring metal layer SD1 further includes a plurality of other conductive transfer structures. The plurality of conductive transfer structures include a first conductive transfer structure PAD1, a second conductive transfer structure PAD1, a third conductive transfer structure PAD3, a fourth conductive transfer structure PAD4, a fifth conductive transfer structure PAD5, a sixth conductive transfer structure the transfer structure PAD6, and a seventh conductive conversion structure PAD7.

The first conductive transfer structure PAD1 may be used to electrically connect the first initialization signal line Vinit1 and the first electrode a1 of the first reset transistor T1.

The second conductive transfer structure PAD2 may be used to electrically connect the second initialization signal line Vinit2 and the first electrode a7 of the second reset transistor T7.

The third conductive transfer structure PAD3 may be used to electrically connect the third initialization signal line Vinit3 and the first electrode a8 of the third reset transistor T8.

The fourth conductive transfer structure PAD4 may be used to electrically connect the data writing signal line Data and the first electrode a4 of the data writing transistor T4.

The fifth conductive transfer structure PAD5 may be used to electrically connect the storage capacitor Cst (the second plate of the storage capacitor Cst) and the first power supply signal line Vdd.

The sixth conductive transfer structure PAD6 may be used to be electrically connect the first electrode a5 of the first light-emitting control transistor T5 and the first power supply signal line Vdd.

In addition, the plurality of conductive transfer structures may further include a seventh conductive transfer structure PAD7. The seventh conductive transfer structure PAD7 may be equivalent to the fourth node N4 (as shown in FIG. 5). The seventh conductive transfer structure PAD7 may be used to electrical connect the second electrode b6 of the second light-emitting control transistor T6 and the light-emitting device O (an anode layer).

For example, a material of the first wiring metal layer SD1 may be a titanium (Ti)-aluminum (Al)-titanium (Ti) multi-layered composite material.

For example, a first planarization layer (PLN) is provided between the first wiring metal layer SD1 and the second gate metal layer Gate2. The first wiring metal layer SD1 is electrically insulated from the second gate metal layer Gate2 through the first planarization layer.

For example, a material of the first planarization layer may be an organic material. For example, the material of the first planarization layer may include at least one of polyimide (PI), acrylic-based polymer, or silicon-based polymer.

As shown in FIGS. 9 and 19, the second wiring metal layer SD2 is located on a side of the first wiring metal layer SD1 away from the first gate metal layer Gate1. The second wiring metal layer SD2 includes: a plurality of first power supply signal lines Vdd extending in the second direction Y and arranged in the first direction X, and a plurality of data writing signal lines Data extending in the second direction Y and arranged in the first direction X. A data writing signal line Data is electrically connected to a column of pixel driving circuits Q.

In some examples, the material of the second wiring metal layer SD2 may be the same as the material of the first wiring metal layer SD1. It can be understood that the material of the second wiring metal layer SD2 may be different from the material of the first wiring metal layer SD1, and the embodiments of the present disclosure do not limit thereto.

For example, a second planarization layer is provided between the second wiring metal layer SD2 and the first wiring metal layer SD1. The second wiring metal layer SD2 is electrically insulated from the first wiring metal layer SD1 through the second planarization layer.

For example, a material of the second planarization layer may be an organic material. For example, the material of the second planarization layer may include at least one of polyimide (PI), acrylic-based polymer, or silicon-based polymer.

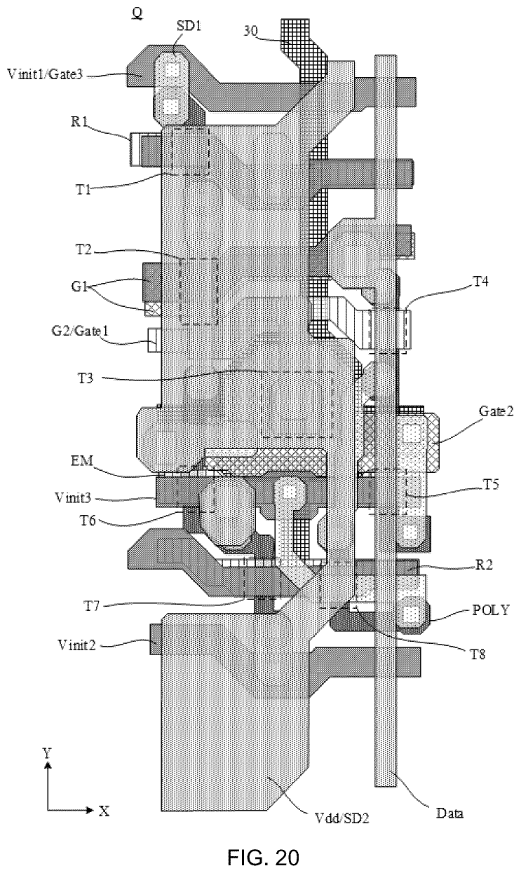

FIG. 20 is a structural diagram of a pixel driving circuit, in accordance with some other embodiments.

In some embodiments, as shown in FIGS. 9 and 20, the difference between the pixel driving circuit Q shown in FIG. 9 and the pixel driving circuit Q shown in FIG. 20 is reflected in the multiple layers in the pixel circuit layer 20 (as shown in FIG. 4) further includes a bottom shield metal (BSM) layer 30. The structure of other film layers corresponding to the pixel driving circuit shown in FIG. 20 is the same as the structure of other film layers corresponding to the pixel driving circuit Q shown in FIG. 9, and may refer to the structural diagram of the film layers corresponding to the pixel driving circuit Q shown in FIG. 9, which will not be repeated here.

The bottom shield metal layer 30 is located on a side of the first semiconductor layer POLY away from the first gate metal layer Gate1. An orthographic projection of the bottom shield metal layer 30 on the substrate 10 (as shown in FIG. 4) covers an orthographic projection of the driving transistor T3 on the substrate 10. In this case, an orthographic projection of the driving transistor T3 on the substrate 10 is within a region covered by the orthographic projection of the bottom shield metal layer 30 on the substrate 10. The bottom shield metal layer 30 is configured to receive a first voltage signal. Wherein, by allowing the bottom shield metal layer 30 to receive the first voltage signal, the accumulation of static electricity in the bottom shield metal layer 30 may be reduced.

The distribution of film layers of the 8 transistors and all the signal lines in the array substrate 100 is described in detail above with reference to the accompanying drawings. On this basis, the planar position relationship of all the transistors in the pixel driving circuit Q will be described in detail below with reference to the accompanying drawings.

In some embodiments, as shown in FIG. 5 and FIGS. 9 to 19, the pixel driving circuit Q includes the compensation transistor T2, the data writing transistor T4 and the driving transistor T3.

In this case, the second electrode b2 of the compensation transistor T2 is electrically connected to the control electrode c3 of the driving transistor T3, the first electrode a2 of the compensation transistor T2 is electrically connected to the second electrode b3 of the driving transistor T3, and the control electrode c2 of the compensation transistor T2 is electrically connected to the first scanning signal line G1. The first electrode a4 of the data writing transistor T4 is electrically connected to the data writing signal line Data, the second electrode b4 of the data writing transistor T4 is electrically connected to the second conductive connection portion M2, and the control electrode c4 of the data writing transistor T4 is electrically connected to the second scanning signal line G2.

Based on the above-mentioned electrical connection between the compensation transistor T2, the data writing transistor T4 and the driving transistor T3, the data writing transistor T4 and the compensation transistor T2 are electrically connected to different electrodes (the first electrode and the second electrode) of the driving transistor T3 respectively, and the data writing transistor T4 and the compensation transistor T2 may be arranged on two sides of the driving transistor T3 respectively, which may beneficial to enable the data writing transistor T4 and the compensation transistor T2 to be electrically connected to the different electrodes of the driving transistor T3 respectively to ameliorate the problems of cross-wire and winding, so that it is possible to help to simplify the layout of the array substrate 100.

In some embodiments, as shown in FIG. 5 and FIGS. 9 to 19, the pixel driving circuit Q further includes a first reset transistor T1, a control electrode c1 of the first reset transistor T1 is electrically connected to a first reset signal line R1, a first electrode a1 of the first reset transistor T1 is electrically connected to a first initialization signal line Vinit1, and the second electrode b1 of the first reset transistor T1 is electrically connected to the third conductive connection portion M3. In the second direction Y, an orthographic projection of the first reset signal line R1 on the substrate 10 is located on a side of the orthographic projection of the first scanning signal line G1 on the substrate 10 away from the orthographic projection of the driving transistor T3 on the substrate 10.

Since the first reset signal line R1 may include the first portion, and the first portion of the first reset signal line R1 is also used as the control electrode c1 of the first reset transistor T1, arranging the first reset signal line R1 on a side of the first scanning signal line G1 away from the driving transistor T3 is equivalent to arranging the first reset transistor T1 on a side of the first scanning signal line G1 proximate to an edge of the pixel driving circuit Q. Thus, the first reset signal line R1 and the first reset transistor T1 may be arranged staggered with the first scanning signal line, which may prevent the parasitic capacitance from being formed between the first scanning signal line G1 and the first reset signal line R1 and first reset transistor T1 to prevent the potential of the first scanning signal transmitted by the first scanning signal line G1 from being affected.

In some embodiments, as shown in FIG. 5 and FIGS. 9 to 19, in the second direction Y, an orthographic projection of the first initialization signal line Vinit1 on the substrate 10 is located on a side of an orthographic projection of the first reset signal line R1 on the substrate 10 away from an orthographic projection of the first scanning signal line G1 on the substrate 10, which is equivalent to a case that the first initialization signal line Vinit1 is arranged at the edge position of the corresponding pixel driving circuit Q. FIG. 6 illustrates an example in which the first initialization signal line Vinit1 is arranged at the upper edge position of the corresponding pixel driving circuit Q.

With such the arrangement, it is possible to prevent the orthographic projection of the first initialization signal line Vinit1 on the substrate 10 from overlapping with the orthographic projections of other transistors and other structures in the corresponding pixel driving circuit Q on the substrate 10, which may not only facilitate the layout of the pixel driving circuit Q, but also prevent the problem of the mutual influence of the potentials caused by the generation of coupling capacitance, so that the stability of the pixel driving circuit Q is improved.

In some embodiments, as shown in FIG. 5 and FIGS. 9 to 19, two adjacent, in the second direction Y, pixel driving circuits Q are included. For the two adjacent pixel driving circuits Q, the first initialization signal line Vinit1 that is electrically connected to the upper pixel driving circuit Q is arranged at an edge of the upper pixel driving circuit Q away from the lower pixel driving circuit Q. Moreover, in the two adjacent pixel driving circuits Q, the first initialization signal line Vinit1 electrically connected to the lower pixel driving circuit Q is arranged at an edge of the upper pixel driving circuit Q proximate to the lower pixel driving circuit Q.

With such the arrangement, the space in the array substrate 100 in a direction perpendicular to the substrate 10 is fully utilized to lay out the pixel driving circuit and the signal lines electrically connected thereto, thereby simplifying the layout of the array substrate 100.

In some examples, for two adjacent pixel driving circuits Q, an orthographic projection, on the substrate 10, of the first initialization signal line Vinit1 that is electrically connected to the lower pixel driving circuit Q overlaps with an orthographic projection, on the substrate 10, of the second reset signal line R2 that is electrically connected to the upper pixel driving circuit Q.

The first initialization signal line Vinit1 is located in the third gate metal layer Gate3, and the second reset signal line R2 is located in the first gate metal layer Gate1; that is, the first initialization signal line Vinit1 and the second reset signal line R2 are arranged in different layers. Based on this, for the two adjacent pixel driving circuits Q, the orthographic projection, on the substrate 10, of the first initialization signal line Vinit1 that is electrically connected to the lower pixel driving circuit Q overlaps with the orthographic projection, on the substrate 10, of the second reset signal line R2 that is electrically connected to the upper pixel driving circuit Q, so that the space in the array substrate 100 in the direction perpendicular to the substrate 10 is fully utilized to simplify the layout of the array substrate 100.

In some embodiments, as shown in FIG. 5 and FIGS. 9 to 19, the pixel driving circuit 100 further includes a first light-emitting control transistor T5 and a second light-emitting control transistor T6. A control electrode c5 of the first light-emitting control transistor T5 is electrically connected to an enable signal line EM, a first electrode a5 of the light-emitting control transistor T5 is electrically connected to a first power supply signal line Vdd, and a second electrode b5 of the first light-emitting control transistor T5 is electrically connected to a second conductive connection portion M2. A control electrode c6 of the second light-emitting control transistor T6 is electrically connected to the enable signal line EM, a first electrode a6 of the second light-emitting control transistor T6 is electrically connected to a third conductive connection portion M3, and a second electrode b6 of the second light-emitting control transistor T6 is electrically connected to a light-emitting device O. In the second direction Y, an orthographic projection of the enable signal line EM on the substrate 10 is located on a side of the orthographic projection of the driving transistor T3 on the substrate 10 away from the orthographic projection of the first scanning signal line G1 on the substrate 10.

Based on this, it is equivalent to arranging the driving transistor T3 and the enable signal line EM together on a side of the first scanning signal line G1, i.e., arranging the driving transistor T3 and the enabling signal line EM staggered from the first scanning signal line G1, which may be helpful to prevent the problem of change in potential caused by the parasitic capacitance generated between each other.

Moreover, the enable signal line EM may include a first portion and a second portion that are spaced apart. The first portion of the enable signal line EM may also be used as the control electrode c5 of the first light-emitting control transistor T5, and the second portion of the enable signal line EM may also be used as the control electrode c6 of the second light-emitting control transistor T6.

Based on this, it is equivalent to arranging the first light-emitting control transistor T5 and the second light-emitting control transistor T6 on a side of the driving transistor T3 away from the first scanning signal line G1, which may prevent the problem that any one or more of the four of the first electrode a3 of the driving transistor T3, the second electrode b3 of the driving transistor T3, the second electrode b5 of the first light-emitting control transistor T5 and the first electrode a6 of the second light-emitting control transistor T6 overlap with the first scanning signal line G1 in the case where the driving transistor T3 is electrically connected to both the first light-emitting control transistor T5 and the second light-emitting control transistor T6, thereby preventing the problem of mutual influence between the potentials of the first scanning signal transmitted by the first scanning signal line G1 and any one or more of the four of the first electrode a3 of the driving transistor T3, the second electrode b3 of the driving transistor T3, the second electrode b5 of the first light-emitting control transistor T5 and the first electrode a6 of the second light-emitting control transistor T6, so as to prevent the problem affecting the stability of the driving transistor T3.

In some embodiments, as shown in FIG. 5 and FIGS. 9 to 19, the array substrate 100 further includes a plurality of second initialization signal lines Vinit2 and a plurality of second reset signal lines R2. The plurality of second initialization signal lines Vinit2 extend in the first direction X and are arranged in the second direction Y, and the plurality of second reset signal lines R2 extend in the first direction X and are arranged in the second direction Y. The pixel driving circuit Q further includes a second reset transistor T7. The control electrode c7 of the second reset transistor T7 is electrically connected to the second reset signal line R2, the first electrode a7 of the second reset transistor T7 is electrically connected to the second initialization signal line Vinit2, and the second electrode b7 of the second reset transistor T7 is electrically connected to the light-emitting device O.

In the second direction Y, the orthographic projection of the second reset signal line R2 on the substrate 10 is located on a side of the orthographic projection of the enable signal line EM on the substrate 10 away from the orthographic projection of the driving transistor T3 on the substrate 10, which is equivalent to arranging the second reset signal line R2 at the edge region of the enable signal line EM proximate to the pixel driving circuit Q, so that the second reset signal line R2 is prevented from overlapping with the first conductive connection portion M1 and second conductive connection portion M2 in the pixel driving circuit Q. As a result, it is possible to avoid the problem of the mutual influence of the potentials caused by the generation of coupling capacitance, so that the stability of the pixel driving circuit Q is improved.

Furthermore, in some examples, the second reset signal line R2 may include a first portion and a second portion that are spaced apart. The first portion of the second reset signal line R2 may also be used as the control electrode c7 of the second reset transistor T7, and the second portion of the second reset signal line R2 may also be used as the control electrode c8 of the third reset transistor T8, which is equivalent to arranging the second reset transistor T7 and the third reset transistor T8 on the side of the enable signal line EM away from the driving transistor T3, i.e., which is equivalent to arranging the second reset transistor T7 and the third reset transistor T8 on the side of the first light-emitting control transistor T5 and the second light-emitting control transistor T6 away from the driving transistor T3.

Based on this, it may be possible to help to arrange the first light-emitting control transistor T5 and the third reset transistor T8 together on a side of the driving transistor T3, so as to facilitate the electrical connection between the second electrode b5 of the first light-emitting control transistor T5 and the third electrode b8 of the third reset transistor T8. Moreover, it may be may be possible to help to arrange the second light-emitting control transistor T6 and the second reset transistor T7 on a side of the driving transistor T3, so as to facilitate the electrical connection between the first electrode a6 of the second light-emitting control transistor T6 and the second electrode b7 of the second reset transistor T7.

In some embodiments, as shown in FIG. 5 and FIGS. 9 to 19, two adjacent, in the second direction Y, pixel driving circuits Q are included. For the two adjacent pixel driving circuits Q, the second initialization signal line Vinit2 that is electrically connected to the upper pixel driving circuit Q is arranged at an edge position of the upper pixel driving circuit Q away from the lower pixel driving circuit Q. Moreover, for the two adjacent pixel driving circuits Q, the second initialization signal line Vinit2 that is electrically connected to the lower pixel driving circuit Q is arranged on a side of the lower pixel driving circuit Q proximate to the upper pixel driving circuit Q.

With such the arrangement, the space in the array substrate 100 in the direction perpendicular to the substrate 10 is fully utilized to lay out the pixel driving circuit and the signal lines electrically connected thereto, thereby simplifying the layout of the array substrate 100.

In some examples, in two adjacent pixel driving circuits Q, an orthographic projection, on the substrate 10, of the second initialization signal line Vinit2 that is electrically connected to the lower pixel driving circuit Q overlap with an orthographic projection, on the substrate 10, of the first reset signal line R1 that is electrically connected to the upper pixel driving circuit Q.

The second initialization signal line Vinit2 is located in the third gate metal layer Gate3, and the first reset signal line R1 is located in the first gate metal layer Gate1; that is, the second initialization signal line Vinit2 and the first reset signal line R1 are arranged in different layers. Based on this, for the two adjacent pixel driving circuits Q, the orthographic projection, on the substrate 10, of the second initialization signal line Vinit2 that is electrically connected to the lower pixel driving circuit Q overlaps with the orthographic projection, on the substrate 10, of the first reset signal line R1 that is electrically connected to the upper pixel driving circuit Q, which may full use the space in the array substrate 100 in the direction perpendicular to the substrate 10, thereby simplifying the layout of the array substrate 100.

In some embodiments, as shown in FIG. 5 and FIGS. 9 to 19, the array substrate 100 further includes a plurality of third initialization signal lines Vinit3 and a plurality of third reset signal lines R3. The plurality of third initialization signal lines Vinit3 extend in the first direction X and are arranged in the second direction Y. The plurality of third reset signal lines R3 extend in the first direction X and are arranged in the second direction Y. The pixel driving circuit Q further includes a third reset transistor T8. The control electrode c8 of the third reset transistor T8 is electrically connected to the third reset signal line R3, the first electrode a8 of the third reset transistor T8 is electrically connected to the third initialization signal line Vinit3, and the second electrode b8 of the third reset transistor T8 is electrically connected to the second conductive connection portion M2. An orthographic projection of the third initialization signal line Vinit3 on the substrate 10 is located on a side of the orthographic projection of the driving transistor T3 on the substrate 10 away from the orthographic projection of the first scanning signal line G1 on the substrate 10.

Thus, it may be possible to prevent the third initialization signal line Vinit1 from overlapping with the driving transistor T3 and the first scanning signal line G1 and other structures to avoid the problem of affecting the potential of the driving transistor T3 caused by the generation of coupling capacitance, which may help improve the stability of the pixel driving circuit Q.

In some embodiments, as shown in FIG. 5 and FIGS. 9 to 19, an orthographic projection of the enable signal line EM on the substrate 10 at least partially overlaps with an orthographic projection of the third initialization signal line Vinit3 on the substrate 10.

The third initialization signal line Vinit3 is located in the third gate metal layer Gate3, and the enable signal line EM is located in the first gate metal layer Gate1, that is, the third initialization signal line Vinit3 and the enable signal line EM are arranged in different layers. Based on this, the orthographic projection of the third initialization signal line Vinit3 on the substrate 10 is set to overlap with the orthographic projection of the enable signal line EM on the substrate 10, which may full use the space of the array substrate 100 in the direction perpendicular to the substrate 10 to simplify the layout of the array substrate 100.

In some embodiments, as shown in FIG. 5 and FIGS. 9 to 19, the orthographic projection of the second conductive connection portion M2 on the substrate 10 at least partially overlaps with the orthographic projection of the signal line EM on the substrate 10, and the orthographic projection of the second conductive connection portion M2 on the substrate 10 at least partially overlaps with the orthographic projection of the third initialization signal line Vinit3 on the substrate 10.

The third initialization signal provided by the third initialization signal line Vinit3 is a constant voltage signal, and the orthographic projection of the second conductive connection portion M2 on the substrate 10 is set to at least partially overlap with the orthographic projection of the third initialization signal line Vinit3 on the substrate 10. Thus, the third initialization signal line Vinit3 may be used to maintain the voltage of the second conductive connection portion M2 to prevent the problem of affecting the potential of the driving transistor T3 when the enable signal provided by the enable signal line EM jumps, which may be beneficial to improving the stability of the pixel driving circuit Q.

In some embodiments, as shown in FIG. 5 and FIGS. 9 to 19, the orthographic projection of the second conductive connection portion M2 on the substrate 10 overlaps with the orthographic projection of the first power supply signal line Vdd on the substrate 10.

The first power supply signal provided by the first power supply signal line Vdd is a constant voltage signal, and the orthographic projection of the second conductive connection portion M2 on the substrate 10 is set to be at least partially overlap with the orthographic projection of the first power supply signal line Vdd on the substrate 10. Thus, the first power supply signal line Vdd may be used to maintain the voltage of the second conductive connection portion M2 to prevent the problem of affecting the potential of the driving transistor T3 when the enable signal provided by the enable signal line EM jumps, which may be beneficial to improving the stability of the pixel driving circuit Q.

The distribution of all the transistors in the array substrate 100 is described in detail above with reference to the accompanying drawings. On this basis, the following will describe in detail how to lay out the first conductive connection portion M1 and the second conductive connection portion M2 in the pixel driving circuit Q with reference to the accompanying drawings, so as to enable the first conductive connection portion M1 and the second conductive connection portion M2 to be non-overlapping with the first scanning signal line.

In some embodiments, as shown in FIG. 5 and FIGS. 9 to FIG. 19, the position of the first conductive connection portion M1 is adjusted to enable the first conductive connection portion M2 is located on a side, in the second direction Y, of the first scanning signal line G1.

With such the arrangement, the first conductive connection portion M1 and the first scanning signal line G1 are arranged staggered, that is, the orthographic projection of the first conductive connection portion M1 on the substrate 10 is non-overlapping with the orthographic projection of the first scanning signal line G1 on the substrate 10.

In this way, it is possible to prevent the first scanning signal line G1 from generating a parasitic capacitance with the first conductive connection portion M1 in the corresponding pixel driving circuit Q, thereby ameliorating the problem of the potential jump caused by the mutual influence between the first scanning signal line G1 and the first conductive connection portion M1. Therefore, it is possible to help improve the stability of the driving transistor T3 (the control electrode c3 of the driving transistor T3), and thereby help ameliorate the problem of lateral crosstalk deterioration.

In some other embodiments, the first conductive connection portion M1 needs to be electrically connected to the control electrode c3 of the driving transistor T3. Furthermore, in a case where the first conductive connection portion M2 is located on a side of the first scanning signal line G1 in the second direction Y, the orthographic projection of the first conductive connection portion M1 on the substrate 10 is located between the orthographic projection of the driving transistor T3 on the substrate 10 and the orthographic projection of the first scanning signal line G1 on the substrate 10.

It is equivalent to arranging the first conductive connection portion M1 on a side of the first scanning signal line G1 proximate to the driving transistor T3, which may be beneficial to reducing the distance between the first conductive connection portion M1 and the control electrode c3 of the driving transistor T3 to facilitate the electrically connection between the two, so as to facilitate the layout of the pixel driving circuit Q.

In some embodiments, as shown in FIG. 5 and FIGS. 9 to 19, in the second direction Y, the second conductive connection portion M2 is located on a side of the first scanning signal line G1.

With such the arrangement, the second conductive connection portion M2 and the first scanning signal line G1 are arranged staggered, that is, the orthographic projection of the second conductive connection portion M2 on the substrate 10 is non-overlapping with the orthographic projection of the first scanning signal line G1 on the substrate 10.

In this way, it is possible to prevent the first scanning signal line G1 from generating a parasitic capacitance with the second conductive connection portion M2 in the corresponding pixel driving circuit Q, thereby ameliorating the problem of the potential jump caused by the mutual influence between the first scanning signal line G1 and the second conductive connection portion M2. Therefore, it is possible to help improve the stability of the driving transistor T3 (the control electrode c3 of the driving transistor T3), and thereby help ameliorate the problem of lateral crosstalk deterioration.

In some other embodiments, as shown in FIG. 5 and FIGS. 9 to 19, in the second direction Y, the second conductive connection portion M2 and the driving transistor T3 are located on the same side of the first scanning signal line G1.

Since the second conductive connection portion M2 may be the second node N2 in the equivalent circuit diagram of the pixel driving circuit Q (as shown in FIG. 5), the second conductive connection portion M2 needs to be electrically connected to the first electrode a3 of the driving transistor T3. By arranging the second conductive connection portion M2 and the driving transistor T3 on the same side of the first scanning signal line G1 in the second direction Y, the second conductive connection portion M2 and the driving transistor T3 may be arranged together to prevent the problem of the potential jump caused by the mutual influence between the first scanning signal line G1 and both the second conductive connection portion M2 and the driving transistor T3 due to a case that a connection component between the second conductive connection portion M2 and the driving transistor T3 cross the first scanning signal line G1. Therefore, it may be beneficial to improve the stability of the driving transistor T3 (the first electrode a3 of the driving transistor T3), thereby help improve the stability of the control electrode c3 of the driving transistor. As a result, it is helpful to improve the problem of lateral crosstalk deterioration.

Herein, the term “across” means that an orthographic projection of the connection component on the substrate 10 overlaps with the orthographic projection of the first scanning signal line G1 on the substrate 10.

It will be noted that, as shown in FIG. 5 and FIGS. 9 to 19, the second conductive connection portion M2 may be the second node N2 in the equivalent circuit diagram of the pixel driving circuit Q, and the first electrode a3 of the driving transistor T3, the second electrode b5 of the first light-emitting control transistor T5, the second electrode b4 of the data writing transistor T4, and the second electrode b8 of the third reset transistor T8 are all electrically connected to the second node N2.

Based on the above connection relationship, the first electrode a3 of the driving transistor T3, the second electrode b5 of the first light-emitting control transistor T5, and the second electrode b4 of the data writing transistor T4 may be formed in the first semiconductor layer POLY by a single patterning process, so that the first electrode a3 of the driving transistor T3, the second electrode b5 of the first light-emitting control transistor T5, and the second electrode b4 of the data writing transistor T4 are directly electrically connected.

As for the third reset transistor T8, the second conductive connection portion M2 may be arranged to electrically connect the second electrode b8 of the third reset transistor T8 and the second electrode b4 of the data writing transistor T4 to achieve that the electrode a3 of the driving transistor T3, the second electrode b5 of the first light-emitting control transistor T5, the second electrode b4 of the data writing transistor T4, and the second electrode b8 of the third reset transistor T8 are all electrically connected to the second node N2.

To sum up, the second conductive connection portion M2 is used to electrically connect the second electrode b8 of the third reset transistor T8 and the second electrode b4 of the data writing transistor T4, and the second conductive connection portion M2 is electrically connected to the first electrode a3 of the driving transistor T3 through the second electrode b4 of the data writing transistor T4. That is, the above-mentioned description of “connection component between the second conductive connection portion M2 and the driving transistor T3” may be the second electrode b4 of the data writing transistor T4.

In some other embodiments, as shown in FIG. 5 and FIGS. 9 to 19, in a case where the second conductive connection portion M2 and the driving transistor T3 are located on the same side of the first scanning signal line G1 in the second direction Y, it is also possible to set the orthographic projection of the second conductive connection portion M2 on the substrate 10 to be on a side, in the first direction, of the orthographic projection of the first conductive connection M1 on the substrate 10 away from the orthographic projection of the compensation transistor T2 on the substrate 10, and set the orthographic projection of the second conductive connection portion M2 on the substrate 10 to be on a side, in the first direction, of the orthographic projection of the driving transistor T3 on the substrate 10 away from the orthographic projection of the compensation transistor T2 on the substrate 10.

Since the data writing transistor T4 and the compensation transistor T2 are electrically connected to different electrodes (the first electrode and the second electrode) of the driving transistor T3 respectively, the data writing transistor T4 and the compensation transistor T2 may be respectively arranged on two sides of the driving transistor T3 to facilitate the wiring layout. Based on this, the second conductive connection portion M2 is arranged on the side of the driving transistor T3 away from the compensation transistor T2, i.e., the second conductive connection portion M2 is arranged on the side of the driving transistor T3 proximate to the data writing transistor T4, which may facilitate the electrical connection between the second conductive connection portion M2 and the second electrode b4 of the data writing transistor T4, thereby facilitating the layout of the pixel driving circuit Q.

The above describes in detail how to layout the first conductive connection portion M1 and the second conductive connection portion M2 in the pixel driving circuit Q in conjunction with the accompanying drawings. The following will describe in detail how to layout the first scanning signal lines in the space corresponding to the pixel driving circuit Q in conjunction with the accompanying drawings.

In some embodiments, as shown in FIG. 5 and FIGS. 9 to 19, the orthographic projection of the first scanning signal line G1 on the substrate 10 is non-overlapping with the orthographic projection of the control electrode c3 of the driving transistor T3 on the substrate 10.

Based on this, it is possible to prevent the generation of parasitic capacitance between the first scanning signal line G1 and the control electrode c3 of the driving transistor T3, thereby ameliorating the potential jump caused by the mutual influence between the first scanning signal line G1 and the control electrode c3 of the driving transistor T3. Therefore, it is possible to help improve the stability of the driving transistor T3 (the control electrode c3 of the driving transistor T3), and thereby help ameliorate the problem of lateral crosstalk deterioration.

In some embodiments, as shown in FIG. 5 and FIGS. 9 to 19, since the first conductive connection portion M1 is electrically connected to the control electrode c3 of the driving transistor T3 and the second electrode b2 of the compensation transistor T2, the potentials of the second electrode b2 of the compensation transistor T2, the first conductive connection portion M1 and the control electrode c3 of the drive transistor T3 will affect one other.

Based on this, the orthographic projection of the first scanning signal line G1 on the substrate 10 is non-overlapping with the orthographic projection of the second electrode b2 of the compensation transistor T2 on the substrate 10, which may prevent parasitic capacitance from generating between the first scanning signal line G1 and the second electrode b2 of the compensation transistor T2, thereby ameliorating the problem of the potential jump caused by the mutual influence between the first scanning signal line G1 and the second electrode b2 of the compensation transistor T2, i.e., prevent the second electrode b2 of the compensation transistor T2 from pulling the potential of the control electrode c3 of the drive transistor T3. Therefore, it is possible to help improve the stability of the driving transistor T3 (the control electrode c3 of the driving transistor T3), and thereby help ameliorate the problem of lateral crosstalk deterioration.

In some embodiments, as shown in FIGS. 13, 16 and 18, the orthographic projection of the first scanning signal line G1 on the substrate 10 may be set to be non-overlapping with the orthographic projection of the control electrode c3 of the driving transistor T3 on the substrate, and the orthographic projection of the first scanning signal line G1 on the substrate 10 may be set to be non-overlapping with the orthographic projection of the second electrode b2 of the compensation transistor T2 on the substrate 10.

Based on this, it is possible to prevent a coupling capacitance from generating between the first scanning signal line G1 and the control electrode c3 of the driving transistor T3 and the second electrode b2 of the compensation transistor T2, which may help improve the stability of the driving transistor T3 (the control electrode c3 of the driving transistor T3), and thereby help ameliorate the problem of lateral crosstalk deterioration.

In some embodiments, as shown in FIG. 5 and FIGS. 9 to 19, the orthographic projection of the first scanning signal line G1 on the substrate 10 is non-overlapping with the orthographic projection of the first electrode a3 of the driving transistor T3 on the substrate 10.

Thus, it is possible to prevent a coupling capacitance from generating between the first scanning signal line G1 and the first electrode a3 of the driving transistor T3, so as to prevent the problem of potential jump caused by the mutual influence between the first scanning signal line G1 and the first electrode a3 of the driving transistor T3 due to a case that a coupling capacitance is generated between the first scanning signal line G1 and the first electrode a3 of the driving transistor T3. Furthermore, it may also be possible to prevent the first electrode a3 of the driving transistor T3 from pulling the potential of the control electrode c3 of the driving transistor T3 based on the gate-source capacitance, which may help improve the stability of the driving transistor T3 and thereby help ameliorate the problem of lateral crosstalk deterioration.

In some embodiments, as shown in FIG. 5 and FIGS. 9 to 19, since the first electrode a3 of the driving transistor T3 is electrically connected to the second electrode b4 of the data writing transistor T4, the potentials of the first electrode a3 of the driving transistor T3 and the second electrode b4 of the data writing transistor T4 will affect each other.

Based on this, in a case where the orthographic projection of the first scanning signal line G1 on the substrate 10 is set to be non-overlapping with the orthographic projection of the first electrode a3 of the driving transistor T3 on the substrate 10, the orthographic projection of the first scanning signal line G1 on the substrate 10 is also set to be non-overlapping with the orthographic projection of the second electrode b4 of the data writing transistor T4 on the substrate 10.

Furthermore, it is possible to prevent a coupling capacitance from generating between the first scanning signal line G1 and the second electrode b4 of the data writing transistor T4, so as to prevent the problem of potential jump caused by the mutual influence between the first scanning signal line G1 and the second electrode b4 of the data writing transistor T4 due to the case that a coupling capacitance is generated between the first scanning signal line G1 and the second electrode b4 of the data writing transistor T4. Thus, it is also possible to prevent the problem of change in potential of the control electrode c3 of the driving transistor T3 caused by the potential interaction between the second electrode b4 of the data writing transistor T4 and the first electrode a3 of the driving transistor T3, which may be beneficial to improving the stability of the driving transistor T3 to help ameliorate the problem of lateral crosstalk deterioration.

In addition, in some other embodiments, as shown in FIG. 5 and FIGS. 9 to 19, the first electrode a3 of the driving transistor T3, the second electrode b5 of the first light-emitting control transistor T5, and the second electrode b4 of the data writing transistor T4 and the second electrode b8 of the third reset transistor T8 are electrically connected to one other.

In addition to setting the orthographic projection of the first scanning signal line G1 on the substrate 10 to be non-overlapping with the orthographic projection of the first electrode a3 of the driving transistor T3 on the substrate 10, and the orthographic projection of the first scanning signal line G1 on the substrate 10 to be non-overlapping with the orthographic projection of the second electrode b4 of the data writing transistor T4 on the substrate 10, the orthographic projection of at least one of the second electrode b5 of the first light-emitting control transistor T5 and the second electrode b8 of the third reset transistor T8 on the substrate 10 may also be set to be non-overlapping with the orthographic projection of the first scanning signal line G1 on the substrate 10.

In this way, it is possible to prevent the problem that the potential of the driving transistor T3 (the first electrode a3 and the control electrode c3) jumps caused by a fact that the potential of any transistor jumps with the first scanning signal transmitted by the first scanning signal line G1.

To sum up, there is a need to avoid that the orthographic projection of the first scanning signal line G1 on the substrate 10 overlaps with the orthographic projection, on the substrate 10, of any one of the first electrode a3 of the driving transistor T3, the second electrode b5 of the first light-emitting control transistor T5, the second electrode b4 of the data writing transistor T4, and the second electrode b8 of the third reset transistor T8 that are electrically connected to the second node N2 in the equivalent circuit (as shown in FIG. 5), so as to prevent from ultimately affecting the driving transistor T3 (the control electrode c3 of the driving transistor T3), which may help ameliorate the problem of lateral crosstalk deterioration.

In some embodiments, as shown in FIG. 5 and FIGS. 9 to 19, the orthographic projection of the first scanning signal line G1 on the substrate 10 is non-overlapping with the orthographic projection of the second electrode b3 of the driving transistor T3 on the substrate 10.

In this way, it is possible to prevent a coupling capacitance from generating between the first scanning signal line G1 and the second electrode b3 of the driving transistor T3, so as to prevent the problem of the potential jump caused by the mutual influence between the first scanning signal line G1 and the second electrode b3 of the driving transistor T3 due to the case that a coupling capacitance is generated between the first scanning signal line G1 and the second electrode b3 of the driving transistor T3. Furthermore, it may also be possible to prevent the second electrode b3 of the driving transistor T3 from pulling the potential of the control electrode c3 of the driving transistor T3 based on the formed capacitance, which may help improve the stability of the driving transistor T3 and thereby help ameliorate the problem of lateral crosstalk deterioration.

In some embodiments, as shown in FIG. 5 and FIGS. 9 to 19, the orthographic projection of the first scanning signal line G1 on the substrate 10 is non-overlapping with the first electrode a3 of the driving transistor T3 on the substrate 10, and the orthographic projection of the first scanning signal line G1 on the substrate 10 is non-overlapping with the orthographic projection of the second electrode b3 of the driving transistor T3 on the substrate 10.

Thus, it is possible to prevent a coupling capacitance from generating between the first scanning signal line G1 and the first electrode a3 and second electrode b3 of the driving transistor T3, so as to prevent the problem of the potential jump caused by the mutual influence between the first scanning signal line G1 and the first electrode a3 and second electrode b3 of the driving transistor T3 due to the case that a coupling capacitance is generated between the first scanning signal line G1 and the first electrode a3 and second electrode b3 of the driving transistor T3. Furthermore, it may also be possible to prevent the first electrode a3 and the second electrode b3 of the driving transistor T3 from pulling the potential of the control electrode c3 of the driving transistor T3 based on the formed capacitance, which may be beneficial to improving the stability of the driving transistor T3, thereby helping ameliorate the problem of lateral crosstalk deterioration.

In some embodiments, as shown in FIG. 5 and FIGS. 9 to 19, the difference from the pixel driving circuit shown in FIG. 6 is that the relative positions of the first scanning signal line G1 and the second scanning signal line G2 are adjusted, so that in the second direction Y, the orthographic projection of the first scanning signal line G1 on the substrate 10 is located on a side of the orthographic projection of the second scanning signal line G2 on the substrate 10 away from the orthographic projection of the driving transistor T3 on the substrate 10.

Since the second scanning signal line G2 needs to be electrically connected to the control electrode c4 of the data writing transistor T4, the second scanning signal line G2 is set to be arranged at a position closer to the driving transistor T3 than the first scanning signal line G1, so that the data writing transistor T4 is arranged on a side of the first scanning signal line G1 proximate to the driving transistor T3.

With such the arrangement, it is possible to help avoid the problem that the second conductive connection portion M2 electrically connected to the second electrode b4 of the data writing transistor T4 needs to cross the first scanning signal line G1, so that the orthographic projection of the first scanning signal line G1 on the substrate 10 is non-overlapping with the orthographic projection of the second conductive connection portion M2 on the substrate 10, so as to reduce voltage jump caused by the mutual influence between the first scanning signal line G1 and the second conductive connection portion M2.

In addition, since the first scanning signal line G1 needs to be electrically connected to the control electrode c2 of the compensation transistor T2, the second scanning signal line G2 is arranged at a position closer to the driving transistor T3 than the first scanning signal line G1, which may set the control electrode c2 of the compensation transistor T2 to be arranged on a side of the second scanning signal line G2 away from the driving transistor T3, so that the second electrode b2 of the compensation transistor T2 may be set to be arranged on a side of the first scanning signal line G1 proximate to the driving transistor T3.

With such the arrangement, it is possible to help avoid the problem that the first conductive connection portion M1 electrically connected to the second electrode b2 of the compensation transistor T2 needs to cross the first scanning signal line G1, so that it is possible to achieve that the orthographic projection of the first scanning signal line G1 on the substrate 10 is non-overlapping with the orthographic projection of the first conductive connection portion M1 on the substrate 10, so as to reduce the voltage jump caused by the mutual influence between the first scanning signal line G1 and the first conductive connection portion M1.

Based on the above embodiments, the present disclosure describes how to implement that the first scanning signal line G1 is non-overlapping with both the first conductive connection portion M1 and the second conductive connection portion M2.

However, the inventors found through researches that, as shown in FIGS. 6 and 9, in the pixel driving circuit Q in FIG. 6, the first conductive connection portion M1 overlaps with both the first scanning signal line G1 and the second scanning signal line G2. In this case, the potential of the first conductive connection portion M1 will be affected by the scanning signals transmitted by the first scanning signal line G1 and the second scanning signal line G2.

After the data writing period, the second scanning signal transmitted by the second scanning signal line G2 is increased from a low voltage signal to a high voltage signal, so that the data writing transistor T4 is turned off by the high voltage signal. Moreover, the first scanning signal transmitted by the first scanning signal line G1 is reduced from a high voltage signal to a low voltage signal, so that the compensation transistor T2 is turned off by the low voltage signal.

That is, during the voltage jump process of the two scanning signal lines, the potential of the first conductive connection portion M1 will be affected. The second scanning signal transmitted by the second scanning signal line G2 is increased from a low voltage signal to a high voltage signal, which will pull up the potential of the first conductive connection portion M1; the first scanning signal transmitted by the first scanning signal line G1 is reduced from a high voltage signal to a low voltage signal, which will pull down the potential of the first conductive connection portion M1.

In this case, the potential of the first conductive connection portion M1 may be made to be at a voltage value within a preset range. Furthermore, the potential compensation is performed by using the data writing signal that is provided by the data writing signal line Data and within a preset range based on the potential of the control electrode c3 of the drive transistor T3 (first conductive connection portion M1), so that the pixel driving circuit Q may drive the light-emitting device O to emit light subsequently.

However, in a case where the pixel driving circuit Q shown in FIG. 6 is adjusted to the pixel driving circuit Q shown in FIG. 9, the case that the first conductive connection portion M1 overlaps both the first scanning signal line G1 and the second scanning signal line G2 is adjusted to the case that the first conductive connection portion M1 is non-overlapping with the first scanning signal line G, and the first conductive connection portion M1 is non-overlapping with the second scanning signal line G2.

That is, the potential of the first conductive connection portion M1 is basically not affected by the first scanning signal transmitted by the first scanning signal line G1, and the potential of the first conductive connection portion M1 is still affected by the second scanning signal transmitted by the second scanning signal line G2.

In this case, since the potential of the first conductive connection portion M1 is still be affected by the second scanning signal transmitted by the second scanning signal line G2, the second scanning signal will pull up the potential of the first conductive connection portion M1, which is equivalent to increasing the potential of the first conductive connection structure M1 to a voltage value higher than the preset range.

Furthermore, the data writing signal from the data writing signal line Data subsequently required by the control electrode c3 of the driving transistor T3 may be lower than the original preset value. For example, the threshold value of the data writing signal from the data writing signal line Data required by the potential of the control electrode c3 of the driving transistor T3 in the pixel driving circuit Q shown in FIG. 6 is in a range of approximately 3 V to approximately 7.5 V, while the threshold value of the data writing signal from the data writing signal line Data required by the potential of the control electrode c3 of the driving transistor T3 in the pixel driving circuit Q shown in FIG. 9 is in a range of approximately 2.8 V to approximately 7.3 V.

In some embodiments, as shown in FIGS. 9 and 14, the compensation transistor T2 includes a semiconductor structure H. The semiconductor structure H includes a first portion H1, a second portion H2 and a third portion H3 that are connected in sequence. The third portion H3 extends in the first direction X, the second portion H2 extends in the second direction Y, and the first portion H1 extends in the first direction X.

In some examples, the semiconductor structure H is substantially in a shape of “L”. A first sub-portion H11 protrudes toward the data writing transistor T4 relative to the second portion H2. In the first direction X, a width of the third portion H3 is substantially equal to a width of the second portion H2.

An orthographic projection of the second portion H2 of the conductor structure H on the substrate 10 (as shown in FIG. 4) overlaps with the orthographic projection of the first scanning signal line G1 on the substrate 10. An orthographic projection of the third portion H3 of the semiconductor structure H on the substrate 10 is located on a side of the orthographic projection of the first scanning signal line G1 on the substrate 10 away from the orthographic projection of the driving transistor T3 on the substrate 10. The third portion H3 of the semiconductor structure H is the first electrode a2 of the compensation transistor T2. Moreover, an orthographic projection of the first portion H1 of the semiconductor structure H on the substrate 10 is located between the orthographic projections of the first scanning signal line G1 and the driving transistor T3 on the substrate 10.

In the extension direction of the second scanning signal line, the first portion H1 includes a first sub-portion H11 and a second sub-portion H12 that are connected. An orthographic projection of the second sub-portion H12 on the substrate 10 is located between the orthographic projection of the first sub-portion H11 on the substrate 10 and the orthographic projection of the control electrode c2 of the compensation transistor T2 on the substrate 10, the first sub-portion H11 is electrically connected to the first conductive connection portion M1. The orthographic projection of the first portion H1 on the first substrate 10 overlaps with the orthographic projection of the second conductive connection structure M2 on the substrate 10. That is, the orthographic projection of the first sub-portion H11 on the substrate 10 and the orthographic projection of the second sub-portion H12 on the substrate 10 overlap with the orthographic projection of the second scanning signal line G2 on the substrate 10. In the first direction X, a width of the first sub-portion H11 is substantially equal to a width of the second portion H2.

In some examples, the first sub-portion H11 is the second electrode b2 of the compensation transistor T2.

With the above structure, since the orthographic projections of the first sub-portion H11 and the second sub-portion H12 in the first portion H1 on the substrate 10 each overlap with the orthographic projection of the second scanning signal line G2 on the substrate 10, resulting in a case that coupling capacitance is generated between each of the first sub-portion H11 and the second sub-portion H12 in the first portion H1 and the second scanning signal line G2, which in turn causes the potentials of the first sub-portion H11 and the second sub-portion H12 and the potential of the second scanning signal transmitted by the second scanning signal line G2 to affect each other. As a result, the potential of the control electrode c3 of the driving transistor T3 is also affected.

In light of this, the embodiments of the present disclosure provide an array substrate 100; an end of the first conductive connection portion M1 is electrically connected to the control electrode c3 of the driving transistor T3, and the other end of the first conductive connection portion M1 is electrically connected to the second electrode b2 of the compensation transistor T2, so that the potential of the control electrode c3 of the driving transistor T3 may be compensated by adjusting the overlapping region between the second scanning signal line G2 and the second electrode b2 of the compensation transistor T2.

The overlapping region between the second scanning signal line G2 and the second electrode b2 of the compensation transistor T2 may be adjusted based on a size of the first portion H11 of the semiconductor structure H in the compensation transistor T2 to compensate for the potential of control electrode c3 of the driving transistor T3.

In some embodiments, as shown in FIGS. 9 and 14, the semiconductor structure H includes a first portion H1, a second portion H2 and a third portion H3 that are connected in sequence. The structure constituted by the second portion H2 and the third portion H3 extends in the second direction Y, and an orthographic projection of the third conductive connection portion M3 on the substrate overlaps with an orthographic projection of the second portion H2 on the substrate.

The second portion H2 in connected to the third portion H3 to constitute a structure extending in the second direction Y; that is, when forming the second portion H2 and the third portion H3, a structure extending in the second direction Y may be formed first, doping and other operations are performed on the structure to form the corresponding second portion H2 and third portion H3. Thus, the process of forming the semiconductor structure H may be simplified.

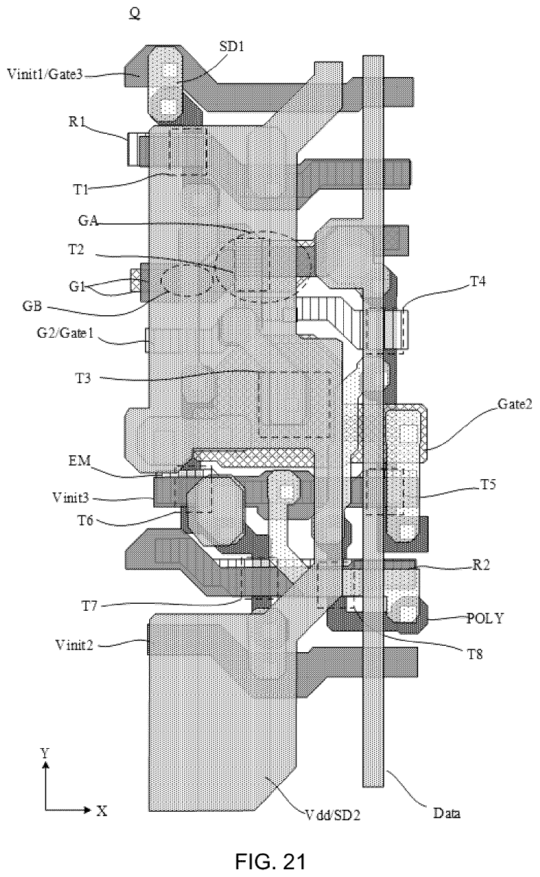

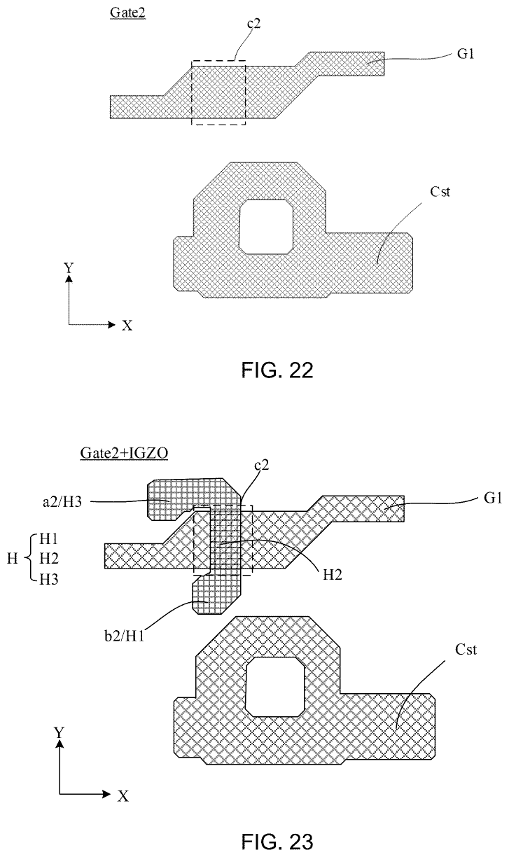

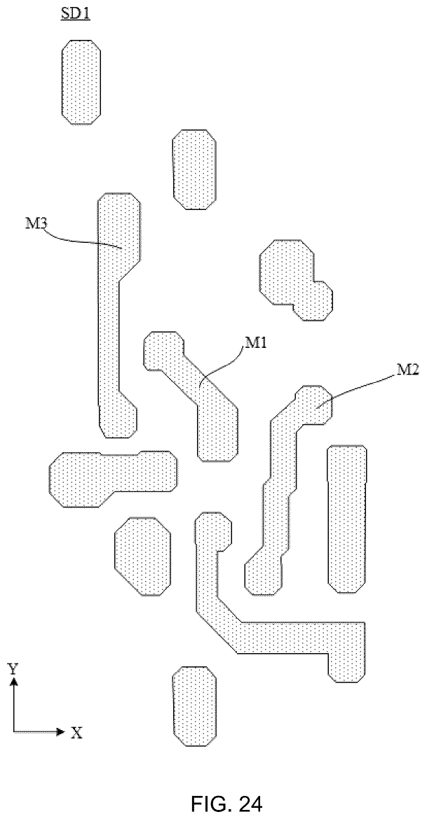

FIG. 21 is a structural diagram of a pixel driving circuit, in accordance with some embodiments; FIG. 22 is a structural diagram of a second gate metal layer in FIG. 21; FIG. 23 is a structural diagram of the second gate metal layer and a second semiconductor layer in FIG. 21; FIG. 24 is a structural diagram of a first wiring metal layer in FIG. 21.

As shown in FIGS. 21 to 24, in some embodiments, the difference between the pixel driving circuit Q shown in FIG. 21 and the pixel driving circuit shown in FIG. 9 is reflected in the first scanning signal line G1 located in the second gate metal layer Gate2, the semiconductor structure of the compensation transistor T2 located in the second semiconductor layer IGZO, and the first conductive connection portion M1 located in the first wiring metal layer SD1. Based on this, FIGS. 22 to 24 illustrate the structural diagrams of the corresponding film layers. As for other layers such as the first semiconductor layer POLY, the first gate metal layer Gate1, the third gate metal layer Gate3, and the second wiring metal layer SD2, reference will be made to the description of the corresponding film layers in the pixel driving circuit Q shown in FIG. 9, which will not be repeated here.

As shown in FIG. 23, the compensation transistor T2 includes a semiconductor structure H, and the semiconductor structure H includes a first portion H1, a second portion H2, and a third portion H3 that are connected in sequence. The third portion H3 extends in the first direction X, the second portion H2 extends in the second direction Y, and the first portion H1 extends in the first direction X.

In some examples, the semiconductor structure H is substantially in a shape of “┐”. In the first direction X, a length of the third portion H3 is greater than a width of the second portion H2, and the third portion H3 towards a side away from the data writing transistor T4 relative to the second portion H2. In the first direction X, a width of the first portion H1 may be substantially equal to the width of the second portion H2.

An orthographic projection of the second portion H2 of the semiconductor structure H on the substrate 10 (as shown in FIG. 4) overlaps with an orthographic projection of the first scanning signal line G1 (the control electrode c3 of the driving transistor T3) on the substrate 10. An orthographic projection of the third portion H3 of the semiconductor structure H on the substrate 10 is located on a side of the orthographic projection of the first scanning signal line G1 on the substrate 10 away from the orthographic projection of the driving transistor T3 on the substrate 10. The third portion H3 of the semiconductor structure H is the first electrode a2 of the compensation transistor T2. Moreover, the orthographic projection of the first portion H1 of the semiconductor structure H on the substrate 10 is located between the orthographic projection of the first scanning signal line G1 on the substrate 10 and the orthographic projection of the driving transistor T3 on the substrate 10. The first portion H1 is electrically connected to the first conductive connection portion M1, and the orthographic projection of the first portion H1 on the substrate 10 overlaps with the orthographic projection of the second scanning signal line G2 on the substrate 10.

In some examples, the first portion H1 is the second electrode b2 of the compensation transistor T2.

The difference from the pixel driving circuit Q shown in FIG. 9 is that the structure of the semiconductor structure H in the compensation transistor T2 is adjusted so that the first portion H1 becomes the second electrode b2 of the compensation transistor T2. Furthermore, the first portion H1 of the semiconductor structure H shown in FIG. 21 may be equivalent to the first sub-portion H11 of the first portion H1 in the pixel driving circuit Q shown in FIG. 9. That is, the first portion H1 of the semiconductor structure H in the compensation transistor T2 that have been adjusted only includes the first sub-portion H11 forming the second electrode b2 of the compensation transistor T2, and does not include the corresponding second sub-portion H12 (as shown in FIG. 9).

Based on this, it is equivalent to a case that the orthographic projection of the second scanning signal line G2 on the substrate 10 only overlaps with the orthographic projection of the first portion H1 forming the second electrode b2 of the compensation transistor T2 on the substrate 10, which may be beneficial to reducing the coupling capacitance generated between the second scanning signal line G2 and the second electrode b2 of the compensation transistor T2 (the first portion H1 of the semiconductor structure H), thereby reducing the change in the potential of the control electrode c3 of the driving transistor T3 pulled by the second scanning signal transmitted on the second scanning signal line G2, and correspondingly, the influence on the range of the data writing signal on the data writing signal line Data may also be reduced to prevent the driver integrated circuit from being unable to provide the reduced data writing signal. As a result, it is possible to help improve the display effect of the display panel 200.

The above embodiments describe the interaction between the data writing signal line Data and the control electrode c3 of the driving transistor T3 in conjunction with the accompanying drawings. However, the inventors found through researches that the reason for affecting the potential of the control electrode c3 of the driving transistor T3 to affect the range of the data writing signal transmitted by the data writing signal line Data is not only limited to the first scanning signal line G1 and the second scanning signal line G2, but also related to the magnitude of the first power supply signal transmitted by the first power supply signal line Vdd.

The pixel driving circuit Q outputs a current I=β(Vdata−V_{dd})² to the light-emitting device O, where β is a known value, Vdata is a voltage value of the data writing signal, and V_{dd} is a voltage value of the first power supply signal.

It can be seen from the above description that the magnitude of the current is related to both the data writing signal transmitted by the data writing signal line Data and the first power supply signal transmitted by the first power supply signal line Vdd. Furthermore, the first power supply signal transmitted by the first power supply signal line Vdd is reduced, resulting in the increase of the data writing signal transmitted by the data writing signal line Data, and resulting in a case that the driver integrated circuit (IC) in the display panel 200 is unable to provide a reduced data writing signal, which will affect the display effect of the display panel 200.

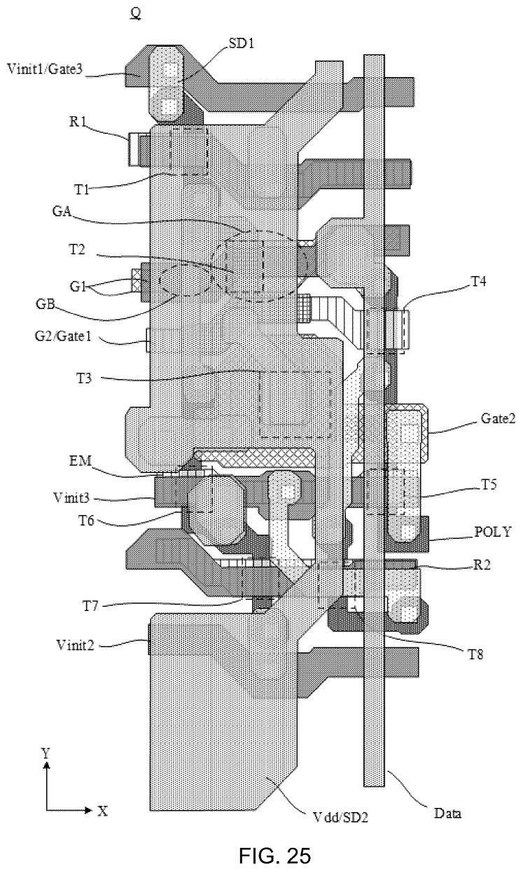

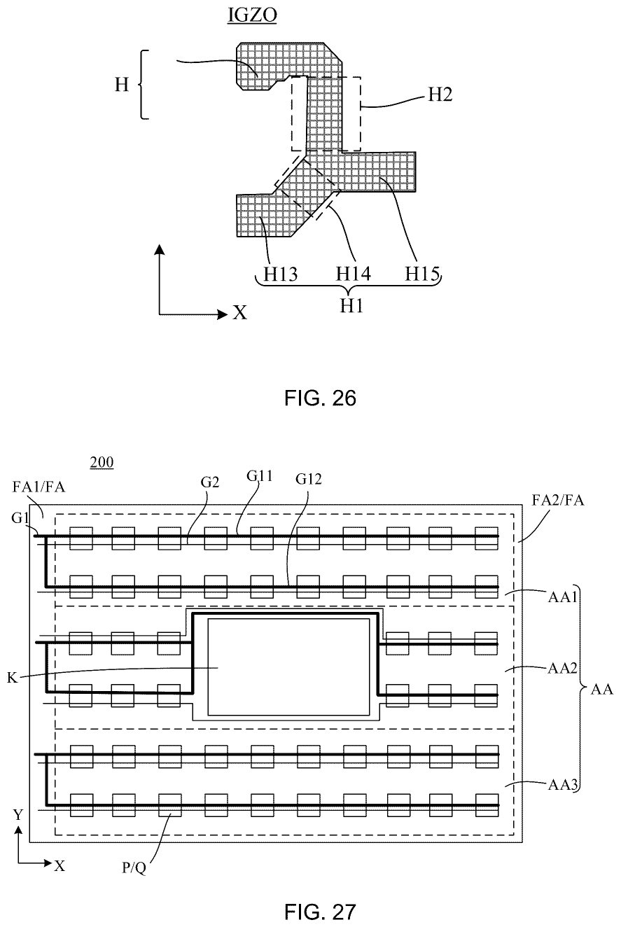

FIG. 25 is a structural diagram of a pixel driving circuit, in accordance with some embodiments. FIG. 26 is a structural diagram of a second semiconductor layer in FIG. 25.

As shown in FIGS. 25 and 26, in some other embodiments, the difference between the pixel driving circuit Q shown in FIG. 25 and the pixel driving circuit Q shown in FIG. 21 is reflected in the semiconductor structure of the compensation transistor T2 located in the second semiconductor layer IGZO. Based on this, FIG. 26 illustrates the structural diagram of the second semiconductor layer IGZO. As for other film layers such as the second gate metal layer Gate2 and the first wiring metal layer SD1, reference will be made to the description of the corresponding film layers in the pixel driving circuit Q shown in FIG. 21. Moreover, the first semiconductor layer POLY, the first gate metal layer Gate1, the third gate metal layer Gate3, and the second wiring metal layer SD2 are substantially the same as those shown in FIG. 21, and may also be refer to the structural diagram of the corresponding film layers in the driving circuit Q shown in FIG. 9, and will not be repeated here.

As shown in FIG. 26, the compensation transistor T2 includes a semiconductor structure H, and the semiconductor structure H includes a first portion H1, a second portion H2 and a third portion H3 that are connected in sequence. The third portion H3 extends in the first direction X, the second portion H2 extends in the second direction Y, and the first portion H1 extends in the first direction X.

An orthographic projection of the second portion H2 of the semiconductor structure H on the substrate 10 (as shown in FIG. 4) overlaps with the orthographic projection of the first scanning signal line G1 (the control electrode c3 of the driving transistor T3) on the substrate 10. An orthographic projection of the third portion H3 of the semiconductor structure H on the substrate 10 is located on a side of the orthographic projection of the first scanning signal line G1 on the substrate 10 away from the orthographic projection of the driving transistor T3 on the substrate 10. The third portion H3 of the semiconductor structure H is the first electrode a2 of the compensation transistor T2. Moreover, an orthographic projection of the first portion H1 of the semiconductor structure H on the substrate 10 is located between the orthographic projection of the first scanning signal line G1 on the substrate 10 and the orthographic projection of the driving transistor T3 on the substrate 10.

In the extending direction of the second scanning signal line G2, the first portion H1 includes a third sub-portion H13, a fourth sub-portion H14 and a fifth sub-portion H15 that are connected. The fourth sub-portion H14 is located between the third sub-portion H13 and the fifth sub-portion H15. The fourth sub-portion H14 is electrically connected to the first conductive connection portion M1. Orthographic projections of the third sub-portion H13, the fourth sub-portion H14 and the fifth sub-portion H15 on the substrate 10 each overlap with the orthographic projection of the second scanning signal line G2 on the substrate 10.

In some examples, the fourth sub-portion H14 is the second electrode b2 of the compensation transistor T2.

In some examples, in the first direction X, a width of the fourth sub-portion H14 may be substantially equal to a width of the second portion H2.

The difference from the pixel driving circuit Q shown in FIG. 9 is that the structure of the semiconductor structure H in the compensation transistor T2 is adjusted, and the first portion H1 may be set to include the third sub-portion H13 and the fifth sub-portion H15 respectively located on two sides of the fourth sub-portion H14 on a basis of including the fourth sub-portion H14 for forming the second electrode b2 of the compensation transistor T2.

Based on this, the third sub-portion H13 and the fifth sub-portion H15 may be used to increase the size of the first portion H1, which may increase the overlapping area between the orthographic projection of the first portion H1 on the substrate 10 and the orthographic projection of the second scanning signal line G2 on the substrate 10, so as to increase the coupling capacitance between the first portion H1 and the second scanning signal line G2. Therefore, the influence of the second scanning signal line G2 on the potential of the control electrode c3 of the driving transistor T3 is increased, thereby compensating for the influence on the potential of the control electrode c3 of the driving transistor T3 when the first power supply signal transmitted by the first power supply signal line Vdd is reduced to compensate for the influence on the range of the data writing signal of the data writing signal line Data when the first power supply signal is reduced, so as to prevent the driver IC from being unable to provide the reduced data writing signal. As a result, it is conducive to improving the display effect of the display panel 200.

In some examples, in the first direction, the length of the third sub-portion H13 and the length of the fifth sub-portion H15 may be adjusted according to the actual situation, which may help compensate for the influence on the range of the data writing signal of the data writing signal line Data when the first power supply signal is reduced to prevent the driver IC from being unable to provide the reduced data writing signal, so that the display effect of the display panel 200 may be improved.

In some embodiments, the compensation transistor T2 includes a semiconductor structure H, and the semiconductor structure H includes a first portion H1, a second portion H2, and a third portion H3 that are connected in sequence. The second portion H2 is the channel of the compensation transistor T2, and the third portion H3 is the first electrode a2 of the compensation transistor T2. The first portion H1 is electrically connected to the first conductive connection portion M1, and the first portion H1 may include the second electrode b2 of the compensation transistor T2. The orthographic projection of the first portion H1 on the substrate 10 and the orthographic projection of the second scanning signal line G2 on the substrate 10 have a first overlapping region, and an area of the first overlapping region is greater than an area of the orthographic projection of the second portion H2 on the substrate 10.

The coupling capacitance between the first portion H1 and the second scanning signal line G2 may be adjusted by adjusting the area of the first overlapping region. Based on this, the orthographic projection of the first portion H1 on the substrate 10 is set to have a first overlapping region with the orthographic projection of the second scanning signal line G2 on the substrate 10, and the area of the first overlapping region is greater than the area of the orthographic projection of the second portion H2 on the substrate 10, which may increase the influence of the second scanning signal line G2 on the potential of the control electrode c3 of the driving transistor T3 by using the area of the first overlapping region, thereby compensating for the influence on the potential of the control electrode c3 of the driving transistor T3 when the first power supply signal transmitted by the first power supply signal line Vdd. As a result, it is possible to help compensate for the influence on the range of the data writing signal on the data writing signal line Data when the first power supply signal is reduced, so as to prevent the driving IC from being unable to provide the reduced data writing signal, which is beneficial to improving the display effect of the display panel 200.

In some examples, a ratio of the area of the first overlapping region to the area of the orthographic projection of the second portion H2 on the substrate 10 is in a range of approximately 2:1 to approximately 10:1.

In a case where the ratio of the area of the overlapping region to the area of the orthographic projection of the second portion H2 on the substrate 10 is equal to or approaches 2:1, the area of the first overlapping region is small, which may reduce the coupling capacitance formed between the second scanning signal line G2 and the second electrode b2 of the compensation transistor T2 (the first portion H1 of the semiconductor structure H), thereby reducing the change in the potential of the control electrode c3 of the driving transistor T3 pulled by the second scanning signal transmitted on the second scanning signal line G2, and correspondingly, the influence on the range of the data writing signal on the data writing signal line Data may also be reduced to prevent the driver IC from being unable to provide the reduced data writing signal. As a result, it is possible to help improve the display effect of the display panel 200.

In a case where the ratio of the area of the overlapping region to the area of the orthographic projection of the second portion H2 on the substrate 10 is equal to or approaches 10:1, the area of the first overlapping region is great, which may increase the coupling capacitance between the first portion H1 and the second scanning signal line G2. Therefore, the influence of the second scanning signal line G2 on the potential of the control electrode c3 of the driving transistor T3 is increased, thereby compensating for the influence on the potential of the control electrode c3 of the driving transistor T3 when the first power supply signal transmitted by the first power supply signal line Vdd is reduced. As a result, it is possible to help compensate for the influence on the range of the data writing signal of the data writing signal line Data when the first power supply signal is reduced, so as to prevent the driver IP from being unable to provide the reduced data writing signal, thereby conducive to improving the display effect of the display panel 200.

For example, the area of the first overlapping region is approximately 2 times, 3 times, 4 times, 5 times, 6 times, 7 times, 8 times, 9 times, or 10 times the area of the orthographic projection of the second portion H2 on the substrate 10, and the embodiments of the present disclosure are not limited thereto. In a case where the internal space of the pixel driving circuit Q is sufficient, the area of the first overlapping region may also be adjusted to be more than 10 times the area of the orthographic projection of the second portion H2 on the substrate 10 according to needs.

In some embodiments, as shown in FIGS. 21 to 26, the compensation transistor T2 includes a semiconductor structure H, and the semiconductor structure H includes a first portion H1, a second portion H2, and a third portion H3 that are connected in sequence. The second portion H2 is the channel of the compensation transistor T2, and the third portion H3 is the first electrode a2 of the compensation transistor T2. The first portion H1 is electrically connected to the first conductive connection portion M1, and the first portion H1 may include the second electrode b2 of the compensation transistor T2.

The first scanning signal line G1 includes a first portion GA and a second portion GB. An orthographic projection of the first portion GA on the substrate 10 overlaps with the orthographic projection of the second portion H2 on the substrate 10. An orthographic projection of the second portion GB on the substrate 10 overlaps with the orthographic projection of the third conductive connection portion M3 on the substrate 10. In the second direction Y, a width of the second portion GB is less than a width of the first portion GA.

Based on this, the structure of the semiconductor structure H in the compensation transistor T2 is adjusted, so that the orthographic projection of the third conductive connection portion M3 on the substrate 10 is non-overlapping with the orthographic projection of the second portion H2 on the substrate 10, the orthographic projection of the third conductive connection portion M3 on the substrate 10 is non-overlapping with the orthographic projection of the first portion GA, with the greater width, of the first scanning signal line G1 on the substrate 10, and the orthographic projection of the third conductive connection portion M3 on the substrate 10 overlaps with the orthographic projection of the second portion GB, with the less width, of the first scanning signal line G1 on the substrate 10.

Furthermore, it may be beneficial to reduce the overlapping area between the orthographic projection of the third conductive connection portion M3 on the substrate 10 and the orthographic projection of the first scanning signal line G1 on the substrate 10, thereby reducing the coupling capacitance formed between the first scanning signal line G1 and the third conductive connection portion M3. As a result, it is possible to reduce the influence on the potential of the third conductive connection portion M3 when the first scanning signal transmitted by the first scanning signal line G1 jumps, thereby helping improve the stability of the driving transistor T3.

In some other embodiments, as shown in FIG. 27, FIG. 27 is a structural diagram of a display panel, in accordance with some other embodiments. The display panel 200 includes a display region AA and a non-display region FA surrounding the display region AA. The display region AA includes a via region K. The display region AA includes multiple sub-pixel regions P, and the multiple sub-pixel regions P may be arranged in an array. The display region AA further includes a first display region AA1, a second display region AA2 and a third display region AA3 in the second direction Y, and the second display region AA2 includes the via region K.

For example, the via region K may be a camera region or a fingerprint recognition region. In the following, only considering an example in which the via region K is a camera region, and the same applies to fingerprint recognition.

The non-display region FA includes a first non-display region FA1 and a second non-display region FA2 that are located on two sides of the display region AA in the first direction X.

For the “8T1C” pixel driving circuit Q in any of the above embodiments, each row of pixel driving circuits Q require multiple scanning signal lines. The multiple scanning signal lines include a first scanning signal lines G1 and a second scanning signal line G2. For example, the multiple signal lines may further include a first reset signal line R1 and a second reset signal line R2.

A corresponding shift register needs to be provided for each scanning signal line, and multiple shift registers need to be provided in the first non-display region FA1 or the second non-display region FA2.

Based on this, the first scanning signal line G1 may employ a manner of “one drive two” and single-side driving (considering the shift registers are arranged in the first non-display region FA1 as an example for introduction). A first scanning signal line G1 may include a first branch G11 of the first scanning signal line and a second branch G12 of the first scanning signal line. The first branch G11 of the first scanning signal line may drive the upper row of pixel driving circuits Q among two adjacent rows of pixel driving circuits Q in the second direction Y, and the second branch G12 of the first scanning signal line may drive the lower row of pixel driving circuits Q among the two adjacent rows of pixel driving circuits Q in the second directions Y. That is, a first scanning signal line G1 may drive two adjacent rows of pixel driving circuits Q in the second direction Y. Thus, it may be beneficial to reduce the number of shift registers corresponding to the first scanning signal line G1, thereby facilitating the realization of the narrow bezel design of the display panel 200.

In addition, in the second display region AA2, multiple pixel driving circuits Q in a row of pixel driving circuits Q need to be electrically connected by a branch (the first branch G11 or the second branch G12) of the first scanning signal line G1. In order to prevent the first scanning signal line G1 from affecting the transmittance of the via region K, a winding design may be used in the via region K. That is, a branch of the first scanning signal line G1 electrically connected to a row of pixel driving circuits Q needs to bypass the via region K. In the same way, the second scanning signal line G2 also needs to be wound.

Based on this, on the basis that the first scanning signal line G1 may employ the manner of “one drive two”, the first branch G11 and the second branch G12, belonging to a same first scanning signal line G1 and being wound in the via region K in the second display region AA2, are merged at the position of the via region K. That is, a connecting line is used to electrically connect the left and right first branches G11 and second branches G12 at the position of the via region K. Thus, it is possible to reduce the number of branches of the first scanning signal line G1, which is beneficial to reducing the occupation of the frame of the via region K by the first scanning signal line G1 and the winding wire to improve the display effect of the display panel 200.

However, the inventors discovered through researches that, after a first branch G11 and a second branch G12 corresponding to a first scanning signal line G1 in the second display region AA2 are electrically connected by a connecting line at the corresponding position of the via region K, the first scanning signal line G1 is divided into a first branch G11 and a second branch G12 again. That is, the first branch G11 and the second branch G12 corresponding to the first scanning signal line G1 in the second display region AA2 are not only electrically connected at the starting end of the first scanning signal line G1 (at the position of the shift register), but also electrically connected at a position corresponding to the via region K.

However, in the first display region AA1 and the third display region AA3, the first branch G11 and the second branch G12 of the first scanning signal line G1 are only electrically connected at the starting end of the first scanning signal line G1 (at the position of the shift register).

Since the first scanning signal line G1 employ the manner of “one drive two”, and the second scanning signal line G2 still employ the manner of “one drive one”, ideally, it will result in a fact that, for multiple pixel driving circuits Q in each row of pixel driving circuits, the potentials of the first conductive connection portion, the second conductive connection portion and the third conductive connection portion will be pulled twice by the same first scanning signal line G1 (the first branch G11 pulls once and the second branch G12 pulls once).

However, due to the voltage drop loading in the first scanning signal line G1 (the voltage drop loading referring to a difference exists between the voltage on two sides of the screen and the voltage in the middle position due to the resistance of a conductive line), which will result in a case that the potentials of the first conductive connection portion, the second conductive connection portion and the third conductive connection portion in the pixel driving circuit Q, far away from the position at which the first branch G11 is electrically connected to the second branch G12, is greatly affected by a branch (the first branch G11) of the first scanning signal line G1, and another case that another branch (the second branch G12) of the same first scanning signal line G1 has a smaller influence on these potentials, and the influence may be ignored.

Based on the above description, it can be seen that in the first display region AA1 and the third display region AA3, the potential of the first conductive connection portion, the second conductive connection portion and the third conductive connection portion in each of the multiple pixel driving circuits Q proximate to the first non-display region FA1 will be pulled twice by the same first scanning signal line G1, and the potential of the first conductive connection portion, the second conductive connection portion and the third conductive connection portion in each of the multiple pixel driving circuits Q away from the first non-display region FA1 and proximate to the second non-display region FA2 will be pulled once by the same first scanning signal line G1.

Since the first branch G11 and the second branch G12 of the first scanning signal line G1 in the second display region AA2 are electrically connected by the same connecting line again at the position of the via region K, which will cause the potentials of the first conductive connection portion, the second conductive connection portion and the third conductive connection portion in each of the multiple pixel driving circuits Q that are located on the left and right sides of the via region K in the second display region AA2 will be pulled by the same first scanning signal line G1 twice.

To sum up, the multiple pixel driving circuits Q, that are far away from the first non-display region FA1 and proximate to the second non-display region FA2, in the display region AA are pulled by the first scanning signal line G1 for different times, which will cause the luminance of the sub-pixel region P in the second display region AA2 be different from the luminance of the sub-pixel region P in the first display region AA1 and the luminance of the sub-pixel region P in the third display region AA3 at the corresponding position, so that the brightness uniformity of the display panel 200 is affected.

In any of the above embodiments, the orthographic projection of the first scanning signal line G1 on the substrate 10 is non-overlapping with the orthographic projection of the first conductive connection portion M1 (as shown in FIG. 9) on the substrate 10 (as shown in FIG. 4), and the orthographic projection of the first scanning signal line G1 on the substrate 10 is non-overlapping with the orthographic projection of the second conductive connection portion M2 on the substrate 10.

In this way, it is possible to ameliorate the influence of the first scanning signal line G1 on the potential of the first conductive connection portion M1 and the second conductive connection portion M2, which may help improve the stability of the driving transistor T3 (the control electrode c3 of the driving transistor T3), and thereby help ameliorate the problem of lateral crosstalk deterioration.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure should be determined by the protection scope of the claims.

1. An array substrate, comprising:
a substrate;
a plurality of pixel driving circuits located on a side of the substrate and arranged in a plurality of rows and a plurality of columns, wherein any pixel driving circuit of the plurality of pixel driving circuits includes: a driving transistor, a compensation transistor electrically connected to the driving transistor, and a first conductive connection portion; and
a plurality of first scanning signal lines located on the side of the substrate, and extending in a first direction and arranged in a second direction, wherein the second direction intersects the first direction;
wherein a control electrode of the driving transistor is electrically connected to the first conductive connection portion, a control electrode of the compensation transistor is electrically connected to a first scanning signal line, a second electrode of the compensation transistor is electrically connected to the first conductive connection portion, and a first electrode of the compensation transistor is electrically connected to a second electrode of the driving transistor; and
an orthographic projection of the first scanning signal line on the substrate is non-overlapping with an orthographic projection of the first conductive connection portion on the substrate.

2. The array substrate according to claim 1, wherein the any pixel driving circuit further includes a second conductive connection portion, and a first electrode of the driving transistor is electrically connected to the second conductive connection portion;
wherein the orthographic projection of the first scanning signal line on the substrate is non-overlapping with an orthographic projection of the second conductive connection portion on the substrate.

3. The array substrate according to claim 1, wherein the orthographic projection of the first conductive connection portion on the substrate is located between an orthographic projection of the driving transistor on the substrate and the orthographic projection of the first scanning signal line on the substrate.

4. The array substrate according to claim 2, wherein the second conductive connection portion and the driving transistor are located on a same side of the first scanning signal line in the second direction; and in the first direction, an orthographic projection of the second conductive connection portion on the substrate is located on a side of the orthographic projection of the first conductive connection portion on the substrate away from an orthographic projection of the compensation transistor on the substrate.

5. The array substrate according to claim 1, wherein the orthographic projection of the first scanning signal line on the substrate is non-overlapping with an orthographic projection of the control electrode of the driving transistor on the substrate.

6. The array substrate according to claim 1, wherein the orthographic projection of the first scanning signal line on the substrate is non-overlapping with an orthographic projection of a first electrode of the driving transistor on the substrate; and/or
the orthographic projection of the first scanning signal line on the substrate is non-overlapping with an orthographic projection of the second electrode of the driving transistor on the substrate.

7. The array substrate according to claim 1, further comprising:
a plurality of data writing signal lines located on the side of the substrate, and extending in the second direction and arranged in the first direction; and
a plurality of second scanning signal lines located on the side of the substrate, and extending in the first direction and arranged in the second direction;
wherein the pixel driving circuit further includes a data writing transistor, a first electrode of the data writing transistor is electrically connected to a data writing signal line, a second electrode of the data writing transistor is electrically connected to a first electrode of the driving transitory, and a control electrode of the data writing transistor is electrically connected to a second scanning signal line; and
in the first direction, an orthographic projection of the data writing transistor on the substrate is located on a side of an orthographic projection of the driving transistor on the substrate away from an orthographic projection of the compensation transistor on the substrate.

8. The array substrate according to claim 7, wherein in the second direction, the orthographic projection of the first scanning signal line on the substrate is located on a side of an orthographic projection of the second scanning signal line on the substrate away from the orthographic projection of the driving transistor on the substrate.

9. The array substrate according to claim 7, wherein the orthographic projection of the first scanning signal line on the substrate is non-overlapping with an orthographic projection of the second electrode of the data writing transistor on the substrate.

10. The array substrate according to claim 1, further comprising:
a plurality of first initialization signal lines located on the side of the substrate, and extending in the first direction and arranged in the second direction; and
a plurality of first reset signal lines located on the side of the substrate, and extending in the first direction and arranged in the second direction;
wherein the pixel driving circuit further includes a first reset transistor; a control electrode of the first reset transistor is electrically connected to a first reset signal line, a first electrode of the first reset transistor is electrically connected to a first initialization signal line, and a second electrode of the first reset transistor is electrically connected to the second electrode of the driving transistor; and
in the second direction, an orthographic projection of the first reset signal line on the substrate is located on a side of the orthographic projection of the first scanning signal line on the substrate away from an orthographic projection of the driving transistor on the substrate.

11. The array substrate according to claim 1, further comprising:
a plurality of enable signal lines located on the side of the substrate, and extending in the first direction and arranged in the second direction; and
a plurality of first power supply signal lines located on the side of the substrate, extending in the second direction and arranged in the first direction;
wherein the pixel driving circuit further includes a first light-emitting control transistor, wherein
a control electrode of the first light-emitting control transistor is electrically connected to an enable signal line, a first electrode of the first light-emitting control transistor is electrically connected to a first power supply signal line, and a second electrode of the first light-emitting control transistor is electrically connected to a first electrode of the driving transistor; and
in the second direction, an orthographic projection of the enable signal line on the substrate is located on a side of an orthographic projection of the driving transistor on the substrate away from the orthographic projection of the first scanning signal line on the substrate.

12. The array substrate according to claim 11, further comprising:
a plurality of second initialization signal lines located on the side of the substrate, and extending in the first direction and arranged in the second direction; and
a plurality of second reset signal lines located on the side of the substrate, and extending in the first direction and arranged in the second direction;
wherein the pixel driving circuit further includes a second reset transistor; a control electrode of the second reset transistor is electrically connected to a second reset signal line, a first electrode of the second reset transistor is electrically connected to a second initialization signal line, and a second electrode of the second reset transistor is configured to be electrically connected to a light-emitting device; and
in the second direction, an orthographic projection of the second reset signal line on the substrate is located on a side of the orthographic projection of the enable signal line on the substrate away from the orthographic projection of the driving transistor on the substrate.

13. The array substrate according to claim 12, further comprising:
a plurality of third initialization signal lines located on the side of the substrate, and extending in the first direction and arranged in the second direction; and
a plurality of third reset signal lines located on the side of the substrate, and extending in the first direction and arranged in the second direction;
wherein the pixel driving circuit further includes a third reset transistor; a control electrode of the third reset transistor is electrically connected to a third reset signal line, a first electrode of the third reset transistor is electrically connected to an third initialization signal line, and a second electrode of the third reset transistor is electrically connected to a first electrode of the driving transistor; and
the orthographic projection of the enable signal line on the substrate at least partially overlaps with an orthographic projection of the third initialization signal line on the substrate.

14. The array substrate according to claim 13, wherein an orthographic projection of the first electrode of the driving transistor on the substrate at least partially overlaps with the orthographic projection of the third initialization signal line on the substrate.

15. The array substrate according to claim 7, wherein the compensation transistor a semiconductor structure, and the semiconductor structure includes a first portion, wherein an orthographic projection of the first portion on the substrate is located between the orthographic projection of the first scanning signal line on the substrate and an orthographic projection of the driving transistor on the substrate; and the first portion is electrically connected to the first conductive connection portion, and the orthographic projection of the first portion on the substrate overlaps with an orthographic projection of the second scanning signal line on the substrate; or
the compensation transistor includes a semiconductor structure, the semiconductor channel of the compensation transistor, the third portion is the first electrode of the compensation transistor, and the first portion is electrically connected to the first conductive connection portion; wherein an orthographic projection of the first portion on the substrate and an orthographic projection of the second scanning signal line on the substrate have a first overlapping region, and an area of the first overlapping region is greater than an area of an orthographic projection of the second portion on the substrate.

16. The array substrate according to claim 7, wherein the compensation transistor a semiconductor structure; the semiconductor structure includes a first portion, and an orthographic projection of the first portion on the substrate is located between the orthographic projection of the first scanning signal line on the substrate and an orthographic projection of the driving transistor on the substrate; and
in an extension direction of the second scanning signal line, the first portion includes a first sub-portion and a second sub-portion that connected; wherein an orthographic projection of the second sub-portion on the substrate is located between an orthographic projection of the first sub-portion on the substrate and an orthographic projection of the control electrode of the compensation transistor on the substrate, and the first sub-portion is electrically connected to the first conductive connection portion;
wherein orthographic projections of the first sub-portion and the second sub-portion on the substrate both overlap with an orthographic projection of the second scanning signal line on the substrate.

17. (canceled)

18. The array substrate according to claim 16, wherein
the semiconductor structure further includes a second portion and a third portion, the second portion is a channel of the compensation transistor, and the third portion is the first electrode of the compensation transistor;
the pixel driving circuit further includes a third conductive connection portion, the first electrode of the compensation transistor is electrically connected to the third conductive connection portion, and the second electrode of the driving transistor is electrically connected to the third conductive connection portion;
wherein an orthographic projection of the third conductive connection portion on the substrate overlaps with an orthographic projection of the second portion on the first substrate.

19. The array substrate according to claim 15, wherein
the semiconductor structure further includes a second portion and a third portion, the second portion is a channel of the compensation transistor, and the third portion is the first electrode of the compensation transistor;
the pixel driving circuit further includes a third conductive connection portion, the first electrode of the compensation transistor is electrically connected to the third conductive connection portion, and the second electrode of the driving transistor is electrically connected to the third conductive connection portion;
the first scanning signal line includes a first portion and a second portion, and an orthographic projection of the first portion of the first scanning signal line on the substrate overlaps with an orthographic projection of the second portion of the semiconductor structure on the substrate, an orthographic projection of the second portion of the first scanning signal line on the substrate overlaps with an orthographic projection of the third conductive connection portion on the substrate, wherein in the second direction, a width of the second portion of the first scanning signal line is less than a width of the first portion of the first scanning signal line;
wherein an orthographic projection of the third conductive connection portion on the substrate is non-overlapping with the orthographic projection of the second portion of the semiconductor structure on the first substrate.

20. A display panel, comprising:
the array substrate according to claim 1; and
a light-emitting device layer located on a side of the array substrate, wherein the light-emitting device layer includes a plurality of light-emitting devices, a light-emitting device is electrically connected to a pixel driving circuit in the array substrate.

21. The array substrate according to claim 16, wherein the semiconductor structure further includes a second portion and a third portion, the first sub-portion protrudes toward the data writing transistor relative to the second portion, and in the first direction, a width of the third portion is substantially equal to a width of the second portion.
